(19) United States
(12) Patent Application Publication
(10) Pub. No.: US 2023/0417905 A1
(43) Pub. Date: Dec. 28, 2023

(54) RADAR ANTENNA UNIT AND RADAR

(71) Applicant: Sumitomo Electric Industries, Ltd., Osaka-shi, Osaka (JP)

(72) Inventors: Yutaro MIKI, Osaka-shi, Osaka (JP); Suguru YAMAGISHI, Osaka-shi, Osaka (JP); Takanori FUKUNAGA, Osaka-shi, Osaka (JP); Ichiro KUWAYAMA, Osaka-shi, Osaka (JP); Hideaki SHIRANAGA, Osaka-shi, Osaka (JP); Nobuo HIGASHIDA, Osaka-shi, Osaka (JP); Eiji MOCHIDA, Osaka-shi, Osaka (JP); Shohei OGAWA, Osaka-shi, Osaka (JP); Yusuke YAHATA, Osaka-shi, Osaka (JP)

(73) Assignee: Sumitomo Electric Industries, Ltd., Osaka-shi, Osaka (JP)

(21) Appl. No.: 18/036,667

(22) PCT Filed: Nov. 18, 2021
(86) PCT No.: PCT/JP2021/042455

§ 371 Date: May 12, 2023

(30) Foreign Application Priority Data
Nov. 24, 2020 (JP) 2020-194081

(51) Int. Cl. G01S 13/931; G01S 7/02

(52) U.S. Cl. CPC G01S 13/931; G01S 7/02

(57) ABSTRACT

A radar antenna of the disclosure is a radar antenna unit including a receiving antenna configured to receive a reflected wave of a radar wave. The receiving antenna includes a plurality of receiving antenna elements arranged at an interval so as to form a row along a first direction. The plurality of receiving antenna elements include a first end antenna element positioned at a first end of the row, a second end antenna element positioned at a second end of the row, and a plurality of intermediate antenna elements positioned between the first end antenna element and the second end antenna element. Of a plurality of the intervals between the plurality of receiving antenna elements, at least one interval differs from other interval. The plurality of receiving antenna elements are disposed such that P_{L}+P_{R}≤P_{AVG}×2 holds. P_{AVG} is from 0.8 λ₀ to 1.2 λ₀. P_{L} is a first end interval.

### TECHNICAL FIELD

The present disclosure relates to a radar antenna unit and a radar. This application claims priority based on Japanese Patent Application No. 2020-194081 filed on Nov. 24, 2020, and the entire contents of the Japanese patent application are incorporated herein by reference.

### BACKGROUND

PTL 1 discloses an array antenna for receiving a reflected wave of a radio wave transmitted from a transmitting antenna of a radar device. The array antenna of the PTL 1 includes a plurality of antenna elements. PTL 1 discloses that intervals of a plurality of antenna elements included in a receiving antenna are equal intervals or unequal intervals.

### PRIOR ART DOCUMENT

### Patent Literature

PTL 1: Japanese Unexamined Patent Application Publication No. 2017-90229

### SUMMARY OF THE INVENTION

One aspect of the present disclosure is a radar antenna unit. The radar antenna of the disclosure is a radar antenna unit including a receiving antenna configured to receive a reflected wave of a radar wave. The receiving antenna includes a plurality of receiving antenna elements arranged at an interval so as to form a row along a first direction. The plurality of receiving antenna elements include a first end antenna element positioned at a first end of the row, a second end antenna element positioned at a second end of the row and a plurality of intermediate antenna elements positioned between the first end antenna element and the second end antenna element. Of a plurality of the intervals between the plurality of receiving antenna elements, at least one interval differs from other interval. The plurality of receiving antenna elements are disposed such that P_{L}+P_{R}≤P_{AVG}×2 holds. P_{AVG} is from 0.8 λ₀ to 1.2 λ₀. P_{L} is a first end interval. The first end interval is an interval between the first end antenna element and a first intermediate antenna element. The first intermediate antenna element is, of the plurality of intermediate antenna elements, an intermediate antenna element positioned adjacent to the first end antenna element. P_{R} is a second end interval. The second end interval is an interval between the second end antenna element and a second intermediate antenna element. The second intermediate antenna element is, of the plurality of intermediate antenna elements, an intermediate antenna element positioned adjacent to the second end antenna element. P_{AVG} is an average of the plurality of the intervals. λ₀ is a wavelength corresponding to a predetermined frequency within a frequency bandwidth of the radar wave.

The radar antenna of another disclosure is a radar antenna unit including a receiving antenna configured to receive a reflected wave of a radar wave. The receiving antenna includes a plurality of receiving antenna elements arranged at an interval so as to form a row along a first direction. The plurality of receiving antenna elements include a first end antenna element positioned at a first end of the row, a second end antenna element positioned at a second end of the row, and at least four or more intermediate antenna elements positioned between the first end antenna element and the second end antenna element. The plurality of intermediate antenna elements include a first intermediate antenna element positioned adjacent to the first end antenna element, and a second intermediate antenna element positioned adjacent to the second end antenna element. Of a plurality of the intervals between the plurality of receiving antenna elements, at least one interval differs from other intervals. The plurality of receiving antenna elements are disposed such that D_{L}+D_{R}<P_{AVG}×3 holds. P_{AVG} is from 0.8 λ₀ to 1.2 λ₀. D_{L} is a first interval. The first interval is an interval between a first central position and the first end antenna element in the first direction. The first central position is a central position in the first direction between the first intermediate antenna element and, of the plurality of intermediate antenna elements, an intermediate antenna element positioned adjacent to the first intermediate antenna element, D_{R} is a second interval. The second interval is an interval between a second central position and the second end antenna element in the first direction. The second central position is a central position in the first direction between the second intermediate antenna element and, of the plurality of intermediate antenna elements, an intermediate antenna element positioned adjacent to the second intermediate antenna element. P_{AVG} is an average of the plurality of the intervals. λ₀ is a wavelength corresponding to a predetermined frequency within a frequency bandwidth of the radar wave.

Another aspect of the present disclosure is a radar. The disclosed radar includes the radar antenna unit.

### BRIEF DESCRIPTION OF THE DRAWINGS

FIG. 1 is a block diagram of a radar.

FIG. 2 is a plan view of a receiving antenna which is a radar antenna.

FIG. 3 is a schematic diagram showing a radar antenna with unequal intervals,

FIG. 4 is a schematic diagram showing a radar antenna with equal intervals.

FIG. 5 is a diagram showing composite directivities of a radar antenna with equal intervals.

FIG. 6 is a diagram showing composite directivities of a radar antenna with unequal intervals and a radar antenna with equal intervals.

FIG. 7 is a diagram showing composite directivities of a radar antenna with unequal intervals and a radar antenna with equal intervals.

FIG. 8 is an explanatory diagram of the relationship between the beam width and the radar recognition ability.

FIG. 9 is an explanatory diagram of a relationship between a side lobe and a radar recognition ability.

FIG. 10 is a diagram showing examples of intervals in the first experiment.

FIG. 11 is a diagram showing examples of intervals in the first experiment.

FIG. 12 is a diagram showing the results of the first experiment.

FIG. 13 is a diagram showing the results of the first experiment.

FIG. 14 is a schematic diagram showing a radar antenna having five elements with unequal intervals.

FIG. 15 is a diagram showing examples of intervals in the second experiment.

FIG. 16 is a diagram showing examples of intervals in the second experiment.

FIG. 17 is a diagram showing examples of intervals in the second experiment.

FIG. 18 is a diagram showing examples of intervals in the second experiment.

FIG. 19 is a diagram showing examples of intervals in the second experiment.

FIG. 20 is a diagram showing the results of the second experiment,

FIG. 21 is a diagram showing the results of the second experiment.

FIG. 22 is a diagram showing the results of the second experiment.

FIG. 23 is a diagram showing the results of the second experiment.

FIG. 24 is a diagram showing the results of the second experiment.

FIG. 25 is a diagram showing a configuration of a radar according to the second embodiment.

FIG. 26 is a plan view of the radar antenna unit, showing the positional relationship of each antenna in the X direction,

FIG. 27 is a plan view of a road on which a radar is installed.

FIG. 28A is a graph showing a results of obtaining a vehicle recognition distance and a lane recognition distance using the experimental product 1.

FIG. 28B is a graph showing a results of obtaining a vehicle recognition distance and a lane recognition distance using the experimental product 2.

FIG. 29A is a graph plotting positions of vehicles recognized by radar of experimental product 1 when a plurality of vehicles are driven only in the same lane.

FIG. 29B is a graph plotting positions after performing tracking by a kalman filter with respect to the positions in FIG. 29A.

FIG. 30A is a graph plotting positions of vehicles recognized by radar of experimental product 2 when a plurality of vehicles are driven only in the same lane.

FIG. 30B is a graph plotting positions after performing tracking by a kalman filter with respect to the position in FIG. 30A.

FIG. 31 is a schematic diagram showing an arrangement of receiving antennas of a radar according to the third embodiment.

FIG. 32 is a diagram showing an arrangement of antenna elements and a beam width in each of the examples and the comparative examples in the fourth experiment.

FIG. 33 is a graph showing the composite directivity of the receiving antenna according to Example 3 and the composite directivity of the receiving antenna according to Comparative Example 1.

FIG. 34 is a schematic diagram showing the arrangement of receiving antennas of the radar used in the fifth experiment.

FIG. 35 is a diagram showing an arrangement of antenna elements and a beam width in each of the examples and the comparative example in the fifth experiment.

FIG. 36 is a graph showing the composite directivity of the receiving antenna according to Example 5 and the composite directivity of the receiving antenna according to Comparative Example 4.

FIG. 37 is a schematic diagram showing the arrangement of receiving antennas of the radar used in the sixth experiment.

FIG. 38 is a diagram showing the arrangement of antenna elements and the beam width in each of the examples and the comparative example in the sixth experiment.

FIG. 39 is a graph showing the composite directivity of the receiving antenna according to Example 8 and the composite directivity of the receiving antenna according to Comparative Example 5.

### DETAILED DESCRIPTION

### Problems to be Solved by Present Disclosure

An array antenna with an unequal interval arrangement may be advantageous in obtaining desired antenna characteristics compared to an array with an equal interval arrangement. In order to improve the recognition ability of the radar, the inventors of the present invention have studied narrowing the angle of the main lobe in the composite directivity of the array antenna by using the unequal interval arrangement. By narrowing the angle of the main lobe, the angular resolution of the radar can be improved.

Here, in the case of an array antenna with an equal interval arrangement, it is preferable that an interval of an antenna element is about 1 λ₀ (λ₀: free space wavelength of a received radio wave). When the interval is 1 λ₀, an aperture length of the array antenna (a length of the array antenna in a direction in which a plurality of antenna elements are arranged) is (the number of antenna elements−1)×λ₀. For example, when the number of antenna elements constituting the array antenna is 4, the aperture length of the array antenna is suitably (4−1) λ₀=3 λ₀. In this case, the average of the intervals of the antenna elements is 1 λ₀. On the other hand, if the aperture length of the array antenna is too large, the side lobe is inwardly angled as the main lobe is narrowed in angle. As a result, if the aperture length of the array antenna is too large, the detectable range of the radar becomes narrow due to the influence of the side lobe. On the other hand, if the aperture length of the army antenna is too small, the main lobe becomes wide, and the angular resolution of the radar decreases.

As described above, if the aperture length of the array antenna is too large or too small, the recognition ability of the radar may be deteriorated.

Therefore, even in the case of the unequal interval arrangement, it is desirable that the aperture length of the array antenna is set to an appropriate size according to the number of antenna elements. Specifically, even in the case of the unequal interval arrangement, it is desirable that the average of the intervals of the antenna elements is about 1 λ₀ as in the case of the equal interval arrangement.

However, the inventors of the present invention have newly found that when there is a restriction that the average of the intervals of the antenna elements is about 1 λ₀ even in the unequal interval arrangement, the angle of the main lobe becomes wider than that in the equal interval arrangement, and the angular resolution of the radar may rather decrease.

Therefore, when the unequal interval arrangement is adopted under the constraint that the average of the intervals of the antenna elements is about 1 λ₀, it is desired to prevent the widening the angle of the main lobe.

### Advantageous Effects of Present Disclosure

According to the present disclosure, when the unequal interval arrangement is adopted tinder the constraint that the average of the intervals of the antenna elements is about 1 λ₀, the widening the angle of the main lobe can be prevented.

[Description of Embodiments of Present Disclosure]

(1) A radar antenna according to an embodiment is a radar antenna unit including a receiving antenna configured to receive a reflected wave of a radar wave. The receiving antenna includes a plurality of receiving antenna elements arranged at an interval so as to form a row along a first direction. The plurality of receiving antenna elements include a first end antenna element positioned at a first end of the row, a second end antenna element positioned at a second end of the row, and a plurality of intermediate antenna elements positioned between the first end antenna element and the second end antenna element. Of a plurality of the intervals between the plurality of receiving antenna elements, at least one interval differs from other intervals. The plurality of receiving antenna elements are disposed such that P_{L}+P_{R}≤P_{AVG}×2 holds. P_{AVG} is from 0.8 λ₀ to 1.2 λ₀. P_{L} is a first end interval. The first end interval is an interval between the first end antenna element and a first intermediate antenna element. The first intermediate antenna element is, of the plurality of intermediate antenna, elements, an intermediate antenna element positioned adjacent to the first end antenna element. P_{R} is a second end interval. The second end interval is an interval between the second end antenna element and a second intermediate antenna element. The second intermediate antenna element is, of the plurality of intermediate antenna elements, an intermediate antenna element positioned adjacent to the second end antenna element. P_{AVG} is an average of the plurality of the intervals. λ₀ is a wavelength corresponding to a predetermined frequency within a frequency bandwidth of the radar wave. In this case, widening the angle of the main lobe can be prevented.

(2) It is preferable that the first intermediate antenna element and the second intermediate antenna element are adjacent to each other, and the plurality of antenna elements are disposed such that P_{L}+P_{M}≥P_{AVG}×2 and P_{M}+P_{R}≥P_{AVG}×2 hold. P_{M} is an interval between the first intermediate antenna element and the second intermediate antenna element. In this case, the first side lobe can be outwardly angled.

(3) Wien the radar antenna unit further includes a pair of transmitting antennas configured to radiate the radar wave and the pair of transmitting antennas are disposed along the first direction, it is preferable that an interval between the pair of transmitting antennas is larger than a distance between the first end antenna element and the second end antenna element.

In this case, if a radar wave is radiated from each of the pair of transmitting antennas, a signal received by the receiving antenna includes a pair of reflected wave signals corresponding to the pair of radar waves radiated from the pair of transmitting antennas. An interval between a pair of transmitting antennas is larger than a distance between the first end antenna element and the second end antenna element. Therefore, a pair of reflected wave signals can be easily separated and obtained from the signals received by each receiving antenna element. As a result, it is possible to obtain the same number of reflected wave signals as in the case of reception by receiving antenna elements twice as many as the number of receiving antenna elements. In other words, it is possible to obtain more reflected wave signals than when a radar wave is radiated from one transmitting antenna by virtually increasing the number of receiving antenna elements. This makes it possible to more effectively prevent widening the angle of the main lobe.

(4) When the radar antenna unit further includes a substrate where the plurality of receiving antenna elements and the pair of transmitting antenna elements are disposed in one row along the first direction, it is preferable that the interval between the pair of transmitting antennas is less than or equal to a value that is determined based on a width of the substrate in the first direction and on the distance.

In this case, the value may be, for example, a value obtained by dividing the width of the substrate in the first direction by the distance between the first end antenna element and the second end antenna element. As a result, the interval between the pair of transmitting antennas is limited, and an increase in the size of the entire unit can be suppressed.

(5) (6) In the radar antenna unit according to (1) to (4) above, it is preferable that the number of the plurality of intermediate antenna elements is two or three, and in the radar antenna unit according to (2) above, it is preferable that the number of the plurality of intermediate antenna elements is two.

(7) A radar antenna according to another embodiment is a radar antenna unit including a receiving antenna configured to receive a reflected wave of a radar wave. The receiving antenna includes a plurality of receiving antenna elements arranged at an interval so as to form a row along a first direction. The plurality of receiving antenna elements include a first end antenna element positioned at a first end of the row, a second end antenna element positioned at a second end of the row, and at least four or more intermediate antenna elements positioned between the first end antenna element and the second end antenna element. The plurality of intermediate antenna elements include a first intermediate antenna element positioned adjacent to the first end antenna element, and a second intermediate antenna element positioned adjacent to the second end antenna element. Of a plurality of the intervals between the plurality of receiving antenna elements, at least one interval differs from other intervals. The plurality of receiving antenna elements are disposed such that D_{L}+D_{R}<P_{AVG}×3 holds. P_{AVG} is from 0.8 λ₀ to 1.2 λ₀. D_{L} is a first interval, the first interval is an interval between a first central position and the first end antenna element in the first direction, and the first central position is a central position in the first direction between the first intermediate antenna element and, of the plurality of intermediate antenna elements, an intermediate antenna element positioned adjacent to the first intermediate antenna element. D_{R} is a second interval, the second interval is an interval between a second central position and the second end antenna element in the first direction, and the second central position is a central position in the first direction between the second intermediate antenna element and, of the plurality of intermediate antenna elements, an intermediate antenna element positioned adjacent to the second intermediate antenna element. P_{AVG} is an average of the plurality of the intervals. λ₀ is a wavelength corresponding to a predetermined frequency within a frequency bandwidth of the radar wave.

Also in this case, widening the angle of the main lobe can be prevented.

(8) A radar according to an embodiment includes the radar antenna unit according to (1) to (7) above. In this case, widening the angle of the main lobe can be prevented, and deterioration of the recognition ability of the radar can be prevented.

### Details of Embodiments of Present Disclosure

### First Embodiment

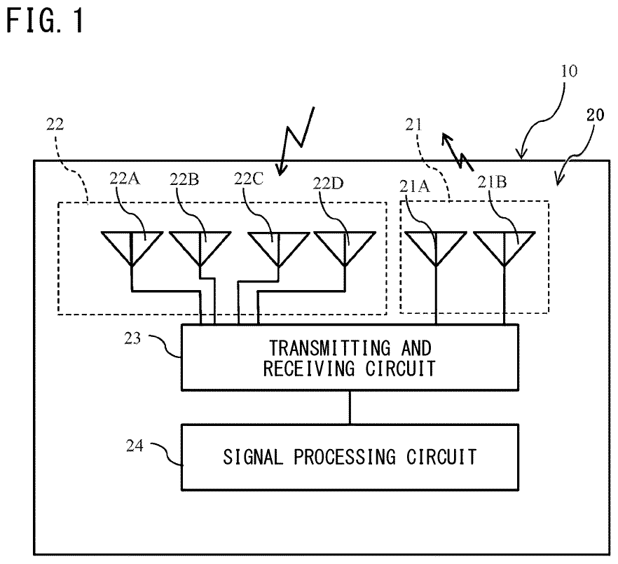

FIG. 1 shows a radar 10 according to the first embodiment. Radar 10 detects an object by emitting radio waves and receiving reflected waves from the object. Radar 10 is installed on or near a road, for example, and is used to detect vehicles, pedestrians, or other objects traveling on the road. Radar 10 may be mounted on a vehicle and used to detect other vehicles or other objects around the vehicle. Radar 10 of the first embodiment is, for example, a millimeter-wave radar. When radar 10 is a millimeter-wave radar, frequencies of radio waves transmitted and received by radar 10 are in a range from 30 GHz to 300 GHz. In this case, a free space wavelength λ₀ of the radio wave is in a range from 1 mm to 10 mm. Radar 10 may use radio waves in a quasi-millimeter wave band.

As shown in FIG. 1, radar 10 includes a radar antenna unit 20. Radar antenna unit 20 includes a transmitting antenna 21 and a receiving antenna 22. Transmitting antenna 21 is configured as an array antenna having a plurality of antenna elements (transmitting antenna elements) 21A and 21B arranged in the horizontal direction. The number of antenna elements constituting transmitting antenna 21 is not particularly limited. The number of antenna elements constituting transmitting antenna 21 is not particularly limited, but is preferably two or more.

A radio wave (radar wave) radiated from transmitting antenna 21 is reflected by an object such as a vehicle. Receiving antenna 22 receives a reflected wave from an object. Receiving antenna 22 is configured as an array antenna having a plurality of antenna elements (receiving antenna elements) 22A, 22B 22C, and 22D. In FIG. 1, the number of the plurality of antenna elements 22A, 22B, 22C, and 22D constituting receiving antenna 22 is, for example, four. The plurality of antenna elements 22A, 22B, 22C, and 22I) are arranged in the horizontal direction.

The number of the plurality of antenna elements 22A, 22B, 22C, and 22D constituting receiving antenna 22 is not particularly limited, but is preferably four or more. In order to prevent an increase in the size of receiving antenna 22 or an increase in the processing load due to an increase in the number of elements, the number of antenna elements is preferably 10 or less, and more preferably 8 or less. Specifically, the number of antenna elements is preferably 4, 5, 6, 7, or 8. More preferably, the number of antenna elements is 4 or 8.

As shown in FIG. 1, radar 10 includes a transmitting and receiving circuit 23 and a signal processing circuit 24. Transmitting antenna 21 and receiving antenna 22 are connected to transmitting and receiving circuit 23. Transmitting and receiving circuit 23 outputs a signal radiated as a radio wave (radar wave) to transmitting antenna 21. The signal radiated as the radio wave is, for example, a Frequency Modulated Continuous Wave (FMCW). Transmitting and receiving circuit 23 outputs the signal of the reflected wave received by receiving antenna 22 to signal processing circuit 24. Signal processing circuit 24 performs processing for detecting a distance, a direction, a speed, and the like to an object from the reflected wave signal.

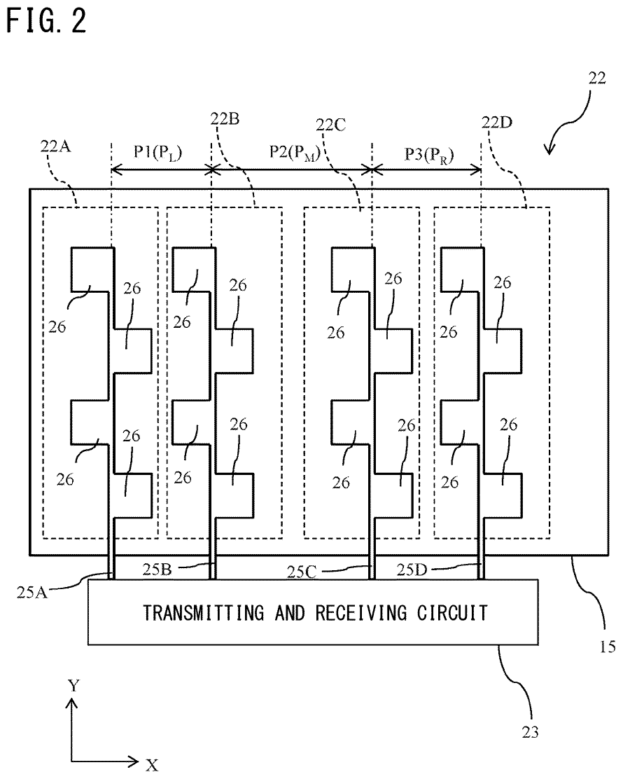

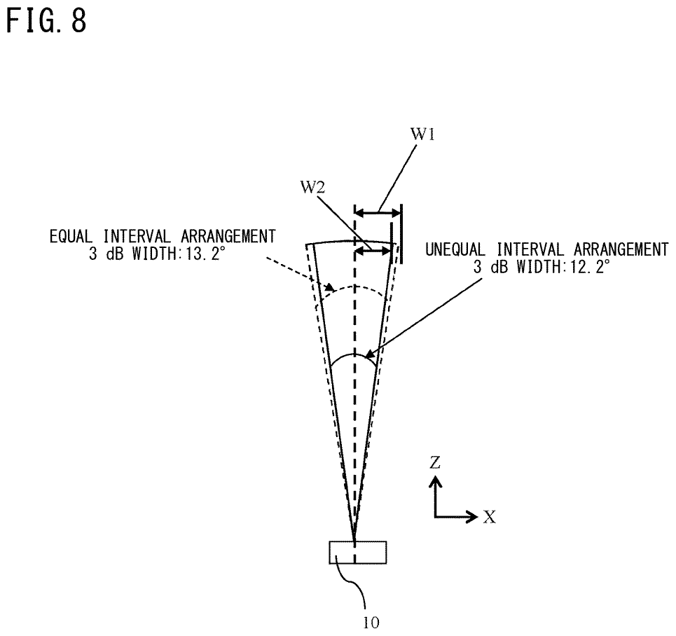

FIG. 2 shows an exemplary configuration of receiving antenna 22, which is a radar antenna. Receiving antenna 22 shown in FIG. 2 is configured as a patch antenna in which a microstrip line is provided on a substrate 15 formed of a material having a low dielectric constant such as a synthetic resin. In FIG. 2, a first direction (left-right direction in FIG. 2) in a plane parallel to the surface of substrate 15 is defined as an X direction, and a second direction (up-down direction in FIG. 2) orthogonal to the first direction is defined as a Y direction. In the following description, the X direction is a horizontal direction, and the Y direction is a vertical direction. A direction orthogonal to the X direction and the Y direction is referred to as a Z direction (see FIG. 8). Receiving antenna 22 receives a radio wave coming from a range including the Z direction.

On substrate 15 shown in FIG. 2, a plurality of antenna elements 22A, 22B, 22C, and 22D arranged at intervals along the X direction (first direction) are provided. It is preferable that the plurality of antenna elements 22A, 22B, 22C, and 22I) have the same shape. Further, it is preferable that the positions of the centers of the plurality of antenna elements 22A, 22B, 22C, and 22D in the Y direction of FIG. 2 are the same in the plurality of antenna elements 22A, 22B, 22C, and 22D. In FIG. 2, each of antenna elements 22A 22B, 22C, and 22D includes a plurality of patch elements 26. Specifically, each of antenna elements 22A 22B, 22C, and 22I) shown in FIG. 2 has four patch elements. Patch elements 26 constituting each of antenna elements 22A, 22B, 22C, and 22D are arranged along the Y direction. Each of antenna elements 22A, 22B, 22C, and 22D includes patch elements 26 having the same shape, number, and arrangement.

A feeder line 25A (line) constituted by a microstrip line is connected to the plurality of patch elements 26 constituting antenna element 22A. A feeder line 25B (line) constituted by a microstrip line is connected to the plurality of patch elements 26 constituting antenna element 22B. A feeder line 25C (line) constituted by a microstrip line is connected to the plurality of patch elements 26 constituting antenna element 22C. A feeder line 25D (line) constituted by a microstrip line is connected to the plurality of patch elements 26 constituting antenna element 22D. Four feeder lines 25A, 25B, 25C and 25D are connected to transmitting and receiving circuit 23. It is preferable that lengths of the plurality of lines 25A, 25B, 25C, and 25D connecting the plurality of antenna elements 22A, 22B, 22C, and 22D to transmitting and receiving circuit 23 are the same. Since the line lengths of the plurality of lines 25A, 25B, 25C, and 25D are the same, the plurality of antenna elements 22A, 22B, 22C, and 22I) can have the same phase. Note that each of antenna elements 22A, 22B, 22C, and 22D may be constituted by one patch element 26 instead of a plurality of patch elements 26.

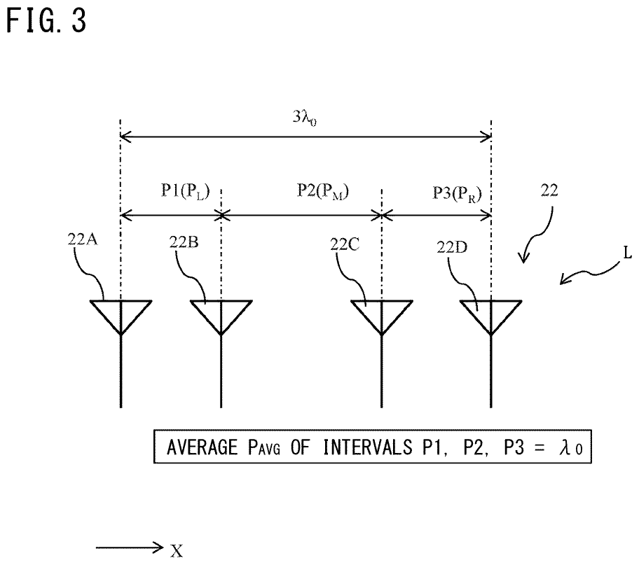

FIG. 3 schematically shows the arrangement of antenna elements 22A, 22B, 22C and 22D of FIG. 2 for ease of understanding. In FIGS. 2 and 3, the intervals of the plurality of antenna elements 22A, 22B, 22C, and 22D are represented by P1, P2, and P3, respectively. P1 indicates an interval between antenna element 22A and antenna element 22B adjacent to antenna element 22A. P1 is a length from the center of first antenna element 22A in the X direction to the center of second antenna element 22B in the X direction. P2 indicates an interval between antenna element 22B and antenna element 22C adjacent to antenna element 22B. P2 is a length from the center of second antenna element 22B in the X direction to the center of third antenna element 22C′ in the X direction. P3 indicates an interval between antenna element 22C and antenna element 22D adjacent to antenna element 22C. P3 is a length from the center of third antenna element 22C in the X direction to the center of fourth antenna element 22D in the X direction.

Among the plurality of antenna elements 22A, 22B, 22C, and 22D, antenna element 22A positioned at one end in the X direction (first direction) is also referred to as a first end antenna element. Among the plurality of antenna elements 22A, 22B, 22C, and 22D, antenna element 22D positioned at the other end in the X direction (first direction) is also referred to as a second end antenna element.

Antenna elements 22B and 22C positioned between a first end antenna element 22A and a second end antenna element 22D are also referred to as intermediate antenna elements. Here, of two intermediate antenna elements 22B and 22C, antenna element 22B is referred to as a first intermediate antenna element, and antenna element 22C; is referred to as a second intermediate antenna element.

That is, the plurality of antenna elements 22A, 22B, 22C, and 22D are arranged in a row so as to form a row L along the first direction.

First end antenna element 22A is positioned at the first end of row L. Second end antenna element 22D is positioned at the second end of row L.

An interval between first end antenna element 22A and a first intermediate antenna element 22B is referred to as a first end interval P_{L}. The aforementioned interval P1 is also first end interval P_{L}. An interval between second end antenna element 22D and a second intermediate antenna element 22C is referred to as a second end interval P_{R}. The aforementioned interval P3 is also second end interval P_{R}. An interval between first intermediate antenna element 22B and second intermediate antenna element 22C is referred to as an intermediate interval P_{M}. The aforementioned interval P2 is also intermediate interval P_{M}.

A parasitic element (not shown) that is not connected to the feeder line may be provided on substrate 15. The parasitic element may be provided between the antenna elements, but when the interval of the antenna elements is defined, the presence of the parasitic element is ignored.

In the first embodiment, intervals P1, P2, and P3 of the plurality of antenna elements 22A, 22B, 22C, and 22D in the X-direction (first direction) are unequal intervals. Here, the unequal interval mean any state other than “equal interval” where all of the plurality of intervals P1, P2, and P3 are the same. All of the plurality of intervals P1, P2, and P3 may be different from each other, but it is sufficient that at least one interval among the plurality of intervals P1, P2, and P3 is different from the other intervals.

In the first embodiment, average P_{AVG} of all antenna element intervals P1, P2, and P3 in the plurality of antenna elements 22A, 22B, 22C, and 22D is about 1 λ₀. Average P_{AVG} is, as an example, 1 λ₀. However, average P_{AVG} does not need to be exactly 1 λ₀, and may be a magnitude that can be regarded as being equal to 1 λ₀. Specifically, average P_{AVG} is preferably in a range from 0.8 λ₀ to 1.2 λ₀. The lower limit of the range of values taken by average P_{AVG} is more preferably 0.85 λ₀ and even more preferably 0.9 λ₀. The upper limit of the range of values taken by average P_{AVG} is more preferably 1.15 λ₀, even more preferably 1.1 λ₀. As an example, average P_{AVG} is more preferably in a range from 0.9 λ₀ to 1.1 λ₀.

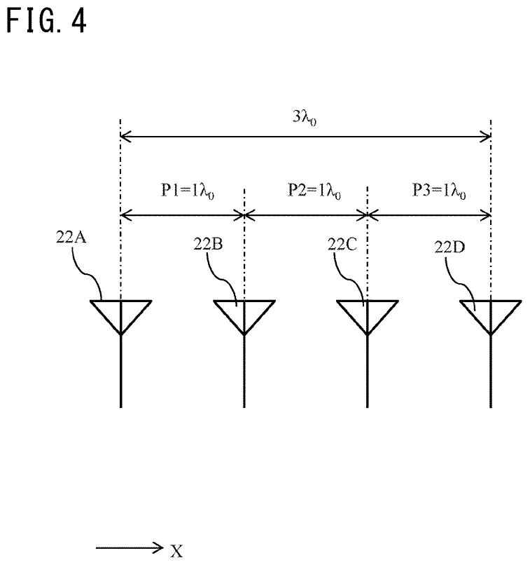

If average P_{AVG} of antenna element intervals P1, P2, and P3, which are intervals of four antenna elements, of the unequal interval arrangement is 1 λ₀, the antenna aperture length (length in the X direction) of receiving antenna 22 (array antenna) is 3 λ₀. In this case, the antenna aperture length of receiving antenna 22 of the unequal interval arrangement is equal to 3 λ₀ which is the antenna aperture length of four antenna elements 22A, 22B 22C, and 22D of the equal interval arrangement (interval: λ₀) shown in FIG. 4.

As described above, even when the plurality of antenna elements 22A, 22B, 22C, and 22D are arranged in the unequal interval arrangement, by setting an interval average P_{AVG} to about 1 λ₀, it is possible to obtain the same antenna aperture length as that in the case of the equal interval arrangement (interval: λ₀) having the same number of elements. Therefore, it is possible to prevent the antenna aperture length of array antenna 22 with the unequal interval arrangement from being too large or too small compared to the array antenna with the equal interval arrangement.

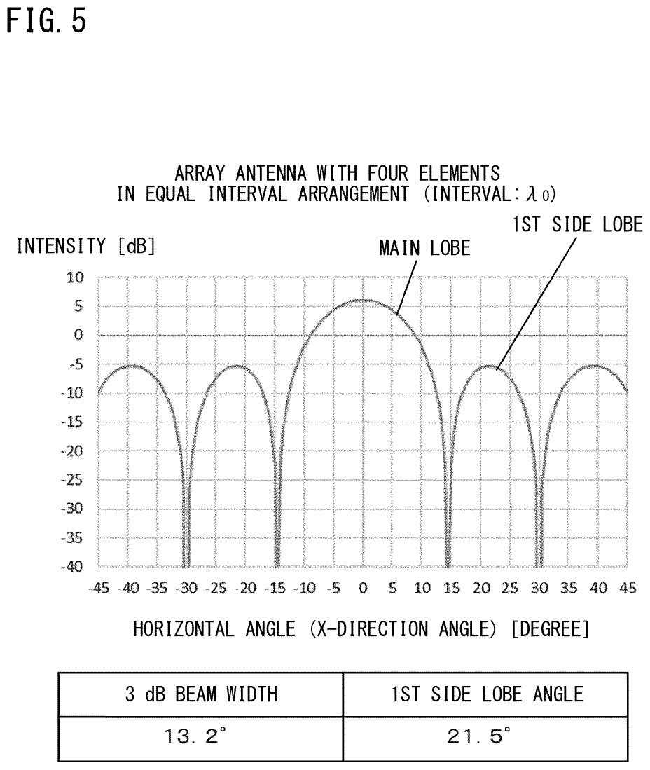

FIG. 5 shows the composite directivity of receiving antenna 22 for the equal interval arrangement shown in FIG. 4. Here, the composite directivity is a composite directivity when the plurality of antenna elements 22A, 22B, 22C, and 22D are point wave sources. In the composite directivity shown in FIG. 4, a beam having the strongest level is called a main lobe. The beams generated on the left and right of the main lobe are called side lobes. The side lobe adjacent to the main lobe is referred to as a first side lobe. In the case of the equal interval arrangement, the 3 dB beam width was 13.2° and the first side lobe angle was 21.5°. The first side lobe angle refers to an angle forming a peak of the first side lobe. The meanings of first side lobe and first side lobe angle are the same hereinafter.

The inventors of the present invention have found that when the plurality of antenna elements 22A, 22B 22C, and 22D are arranged in an unequal interval arrangement while setting interval average P_{AVG} to about 1 λ₀, a disadvantageous characteristic of widening the angle of the main lobe occurs depending on the arrangement.

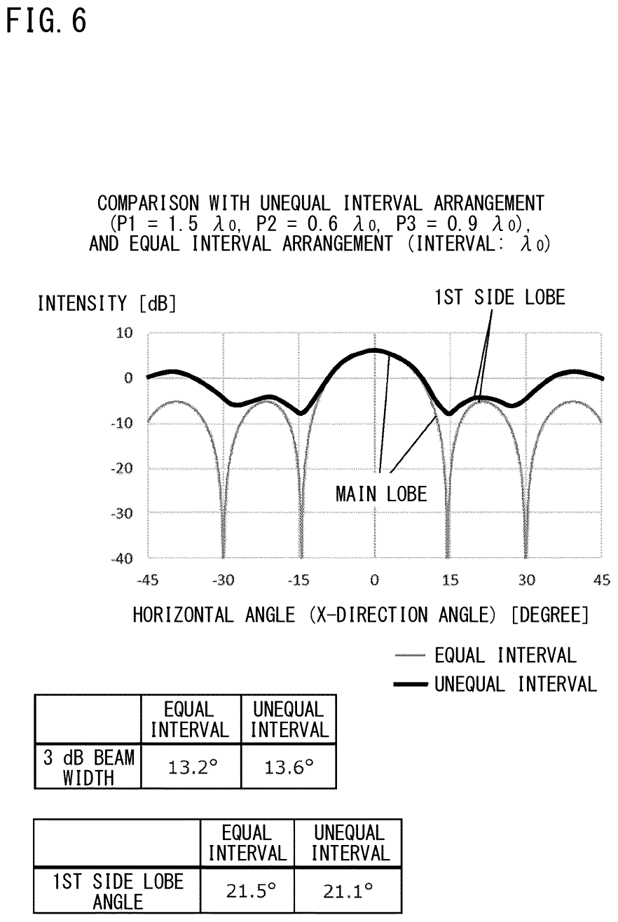

FIG. 6 shows the composite directivities when interval average P_{AVG} is 1 λ₀, interval P1 is 1.5 λ₀, interval P2 is 0.6 λ₀, and interval P3 is 0.9 λ₀. FIG. 6 also shows the composite directivities in an equal interval arrangement (interval: λ₀) similar to FIG. 5. When interval P1 is 1.5 λ₀, interval P2 is 0.6 λ₀, and interval P3 is 0.9 λ₀, the 3 dB beam width is 13.6°, which is larger by 0.4° than the 3 dB beam width of 13.2° in the case of equal interval. That is, in the case of FIG. 6, the angle of the main lobe is widened by making the interval unequal. Further, the first side lobe angle in the case where interval P1 is 1.5 λ₀, interval P2 is 0.6 λ₀, and interval P3 is 0.9 λ₀ is 21.1°, which is smaller than the first side lobe angle of 21.5° in the case of equal interval. That is, in the case of FIG. 6, the first side lobe is brought closer to the main lobe side (inner side) by setting unequal intervals.

Here, as the angle of the main lobe in the composite directivity of receiving antenna 22 becomes narrower, the angular resolution of the radar is improved. However, when interval P1 is set to 1.5 λ₀, interval P2 is set to 0.6 λ₀, and interval P3 is set to 0.9 λ₀, the main lobe has the wide angle, and the recognition ability of the radar is lowered. In addition, the side lobe can be easily separated from the main lobe as the side lobe is more distant from the main lobe to the outside, which is suitable for improving the recognition ability of the radar. However, when interval P1 is set to 1.5 λ₀, interval P2 is set to 0.6 λ₀, and interval P3 is set to 0.9 λ₀, the first side lobe is close to the main lobe, and the radar recognition ability is lowered.

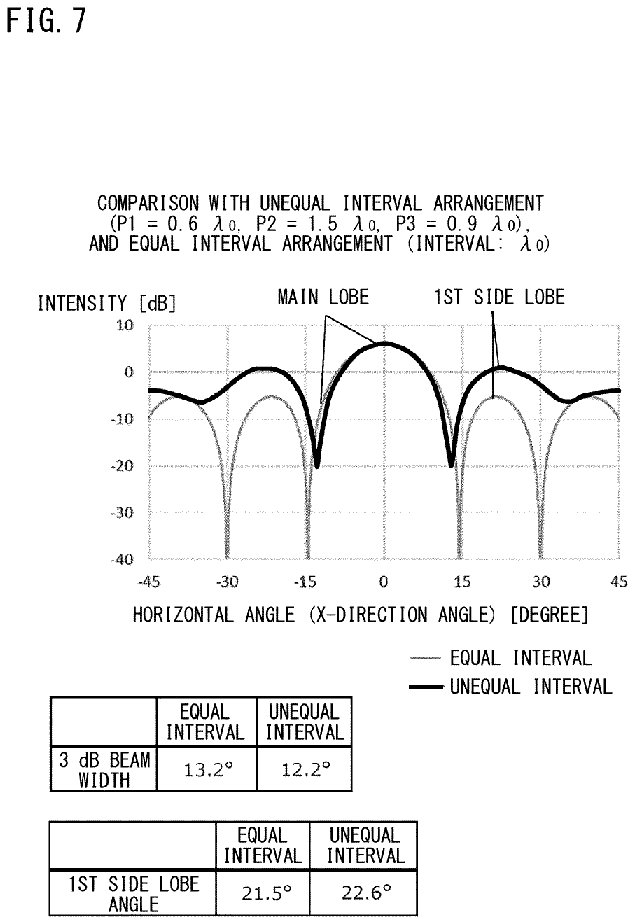

On the other hand, when interval average P_{AVG} is set to about 1 λ₀, and the plurality of antenna elements 22A, 22B, 22C, and 22D are arranged in an unequal interval arrangement, a preferable characteristic of narrowing the angle of the main lobe may be obtained depending on the arrangement. FIG. 7 shows such a preferred example.

That is, FIG. 7 shows the composite directivities when interval average P_{AVG} is 1 λ₀, interval P1 is 0.6 λ₀, interval P2 is 1.5 λ₀ and interval P3 is 0.9 λ₀. FIG. 7 also shows the composite directivities in an equal interval arrangement (interval: λ₀) similar to FIG. 5. When interval P1 is 0.6 λ₀, interval P2 is 1.5 λ₀, and interval P3 is 0.9 λ₀, the 3 dB beam width is 12.2°, which is smaller by 1° than the 3 dB beam width of 13.2° in the case of equal interval. That is, in the case of FIG. 7, the angle of the main lobe is narrowed by making the interval unequal. Further, the first side lobe angle in the case where interval P1 is 0.6 λ₀, interval P2 is 1.5 λ₀, and interval P3 is 0.9 λ₀ is 22.6°, which is larger than the first side lobe angle of 21.5° in the case of equal interval, That is, in the case of FIG. 7, the first side lobe is apart from the main lobe by making the interval unequal.

As shown in FIG. 8, the smaller the 3 dB beam width is, the smaller beam widths W1 and W2 at a position far from radar 10 become. As shown in FIG. 8, beam width W2 when the 3 dB beam width is 12.20 is smaller than beam width W1 when the 3 dB beam width is 13.2°. The difference between beam width W1 and beam width W2 increases as the distance increases. For example, even if the difference in the beam width is 1°, the angular resolution changes in the order of several meters when a distance such as a 200 m is detected. Since the angular resolution is improved as the 3 dB beam width becomes smaller, it is advantageous that the 3 dB beam width is as small as possible.

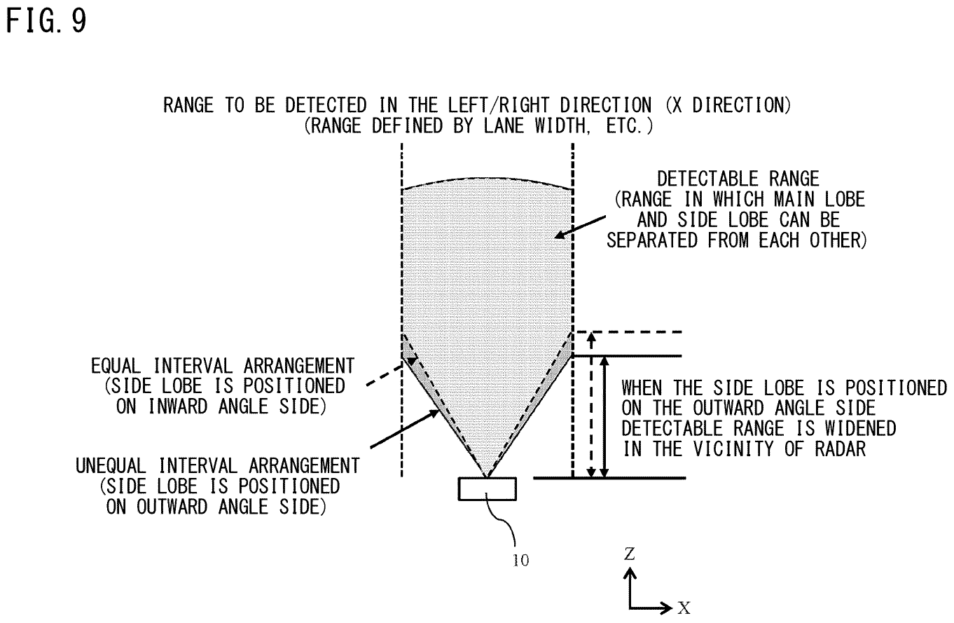

In addition, as the side lobe becomes closer to the outward angle side than the main lobe, a range in which the main lobe and the side lobe can be separated from each other (a region in which a false solution is not obtained: a detectable range) can be widened in the vicinity side. That is, as shown in FIG. 9, when the side lobe is positioned on the outward angle side, the detectable range can be advantageously widened in the vicinity of radar 10 compared with the case where the side lobe is positioned on the inward angle side.

As described above, the narrowing of the angle of the main lobe and the like are advantageous for the improvement of the recognition ability of radar 10, but as shown in FIG. 6, there is a case where the widening the angle is achieved even at unequal intervals. Therefore, even in the unequal interval arrangement, if the arrangement is inappropriate, the recognition ability of radar 10 is rather lowered. With respect to such a problem, the inventors of the present invention have found that there is a condition capable of preventing the widening the angle of the main lobe when interval average P_{AVG} is set to about 1 λ₀ and the interval is set to unequal interval. That is, in the first embodiment, it is preferable that the plurality of antenna elements 22A, 22B, 22C, and 22D are disposed such that P_{L}+P_{R} P_{AVG}×2 holds. When the number of antenna elements is 4 as shown in FIG. 3, it is preferable that P1+P3≤P_{AVG}×2.

That is, it is preferable that the sum of first end interval P_{L} (P1) and second end interval P_{R} (P3) is equal to or less than twice interval average P_{AVG}. When the sum of first end interval P_{L} (P1) and second end interval P_{R} (P3) is sufficiently small, the widening the angle of the main lobe can be prevented. When the sum of first end interval P_{L} (P1) and second end interval P_{R} (P3) is larger than twice interval average P_{AVG}, the angle of the main lobe becomes wider than the equal interval arrangement having the same interval average P_{AVG}, which is disadvantageous. When the angle of the main lobe can be narrowed, the first side lobe can also be outwardly angled in most cases.

More preferably, the plurality of antenna elements 22A, 22B, 22C, and 22D are disposed such that P_{L}+P_{R}<P_{AVG}×2 holds. In other words, the sum of first end interval P_{L} (P1) and second end interval P_{R} (P3) is preferably less than twice interval average P_{AVG}. In this case, the angle of the main lobe can be advantageously narrowed compared to an equal interval arrangement having the same interval average P_{AVG}.

When first intermediate antenna element 22B and second intermediate antenna element 22C are adjacent to each other as in the case of four antenna elements 22A, 22B, 22C and 22D, the plurality of antenna elements 22A, 22B, 22C and 22D are preferably disposed such that P_{L}+P_{M}≥P_{AVG}×2 and P_{M}+P_{R}≥P_{AVG}×2 hold. If the number of antenna elements is 4 as shown in FIG. 3, it is preferable that P1+P2≥P_{AVG}×2 and P2+P3≥P_{AVG}×2. When the conditions of P_{L}+P_{M}≥P_{AVG}×2 and P_{M}+P_{R}≥P_{AVG}×2 are satisfied, the first side lobe can be outwardly angled compared to the equal interval arrangement having the same interval average P_{AVG}.

In the first embodiment, in order to reduce first end interval P_{L} and second end interval P_{R} and prevent the angle of the main lobe from becoming wider, at least one of P_{L} and P_{R} is preferably equal to or less than P_{AVG}. More preferably, at least one of P_{L} and P_{R} is less than P_{AVG}.

In order to reduce first end interval P_{L} and second end interval P_{R} and prevent the angle of the main lobe from becoming wider, it is preferable that P_{L}≤P_{AVG} and P_{R}≤P_{AVG}. It is more preferred that P_{L}<P_{AVG} and P_{R}<P_{AVG}.

In order to reduce first end interval P_{L} and second end interval P_{R} and prevent the angle of the main lobe from becoming wider, at least one of P_{L} and P_{R} is preferably λ₀ or less. More preferably, at least one of P_{L} and P_{R} is less than λ₀.

In order to reduce first end interval P_{L} and second end interval P_{R} and prevent the angle of the main lobe from becoming wider, at least one of P_{L} and P_{R} is preferably 0.9 λ₀ or less, more preferably 0.8 λ₀ or less, and even more preferably 0.7 λ₀ or less.

In order to reduce first end interval P_{L} and second end interval P_{R} and prevent the angle of the main lobe from becoming wider, it is preferable that P_{L}≤λ₀ and P_{R}≤λ₀. It is more preferred that P_{L}<λ₀ and P_{R}<λ₀.

In order to reduce first end interval P_{L} and second end interval P_{R} and prevent the angle of the main lobe from becoming wider, at least one of P_{L} and P_{R} is preferably 0.7 P_{MAX} or less. Here, P_{MAX} is a maximum interval among all antenna element intervals P1, P2, and P3 in a plurality of antenna elements.

In order to reduce first end interval P_{L} and second end interval P_{R} and prevent the angle of the main lobe from becoming wider, at least one of P_{L} and P_{R} is preferably 0.5P_{MAX} or less. P_{MAX} is preferably 2 λ₀ or less.

Hereinafter, an experiment using the radar of the first embodiment will be described.

### [First Experiment: Four Antenna Elements]

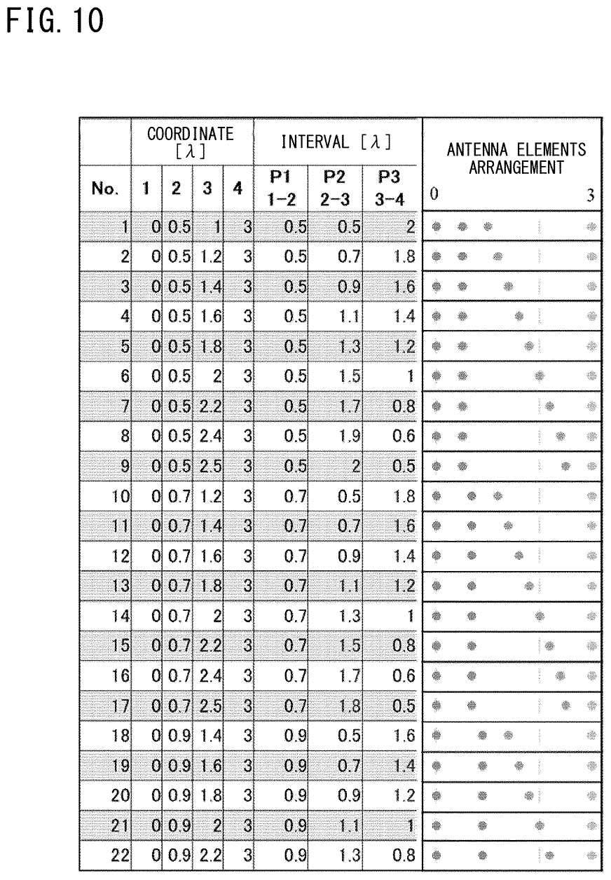

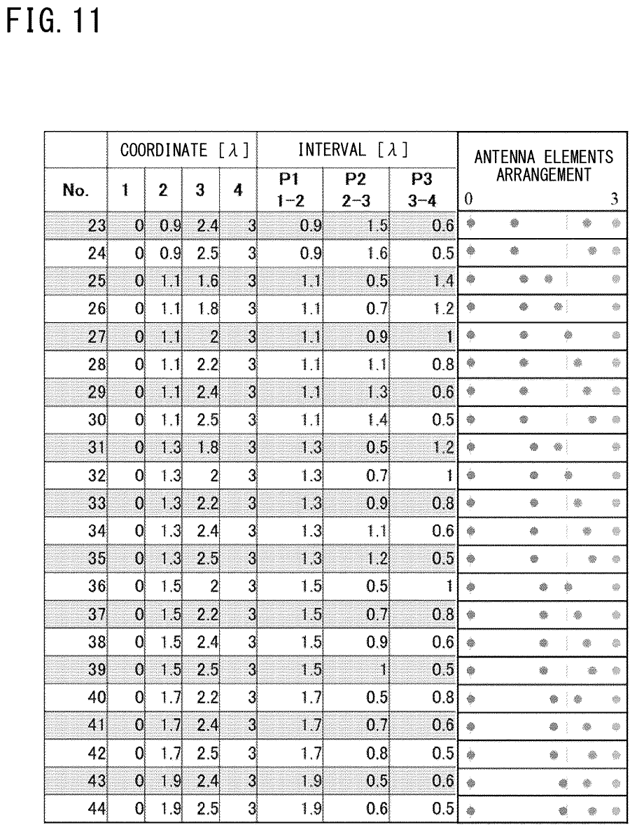

In the first experiment, intervals P1, P2, and P3 in radar antenna 22 having four antenna elements 22A, 22B, 22C, and 22D (see FIG. 3) were changed to various values, and the 3 dB beam width and the first side lobe angle were obtained by directivity composite calculation using a point wave source. In the first experiment, the 3 dB beam width and the first side lobe angle were obtained for each of 44 combinations of P1, P2, and P3 (No. 1 to No44 in FIGS. 10 and 11), In FIG. 10 and FIG. 11, “Coordinate” indicates an X-direction coordinate position where four antenna elements 22A 22B, 22C, and 22D are disposed. In each of No. 1 to N, 44, four antenna elements 22A, 22B, 22C, and 22D are disposed between coordinates 0 and 3. For example, in the case of No. 1, first antenna element 22A is disposed at the position of the X-direction coordinate 0, second antenna element 22B is disposed at the position of the X-direction coordinate 0.5, third antenna element 22C is disposed at the position of the X-direction coordinate 1, and fourth antenna element 22D is disposed at the position of the X-direction coordinate 3. Therefore, P1=0.5 λ₀, P2=0.5 λ₀, and P3=2 λ₀. In FIGS. 10 and 11, the interval is represented as a “Interval”. In FIG. 10 and FIG. 11, λ has the same meaning as λ₀. In FIGS. 10 and 11, “Antenna elements arrangement” indicates an outline of the antenna elements arrangement by a circle.

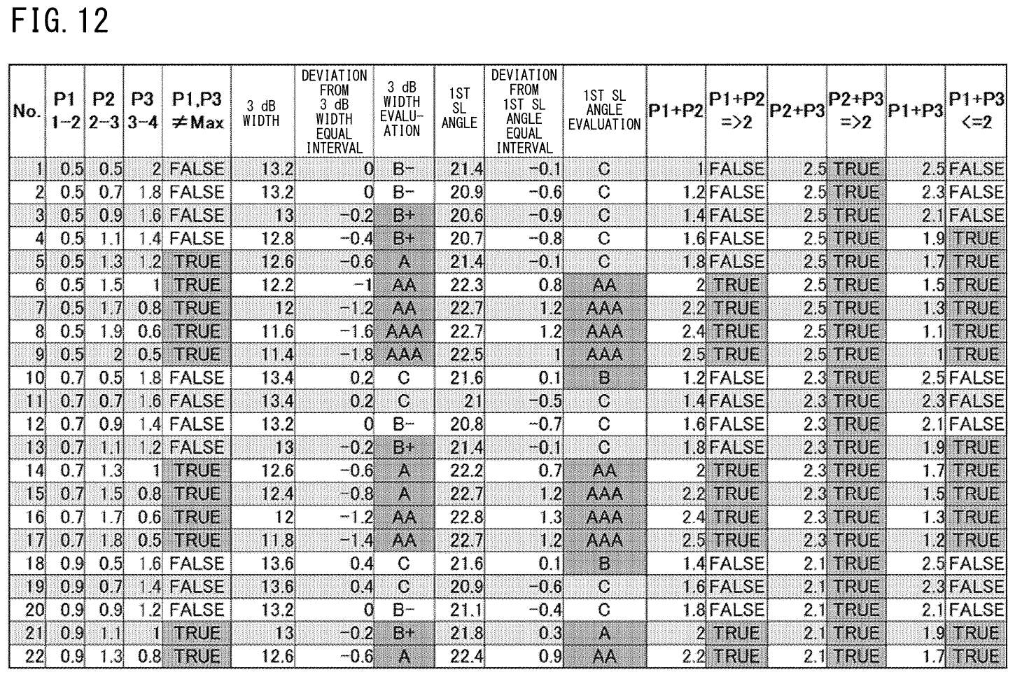

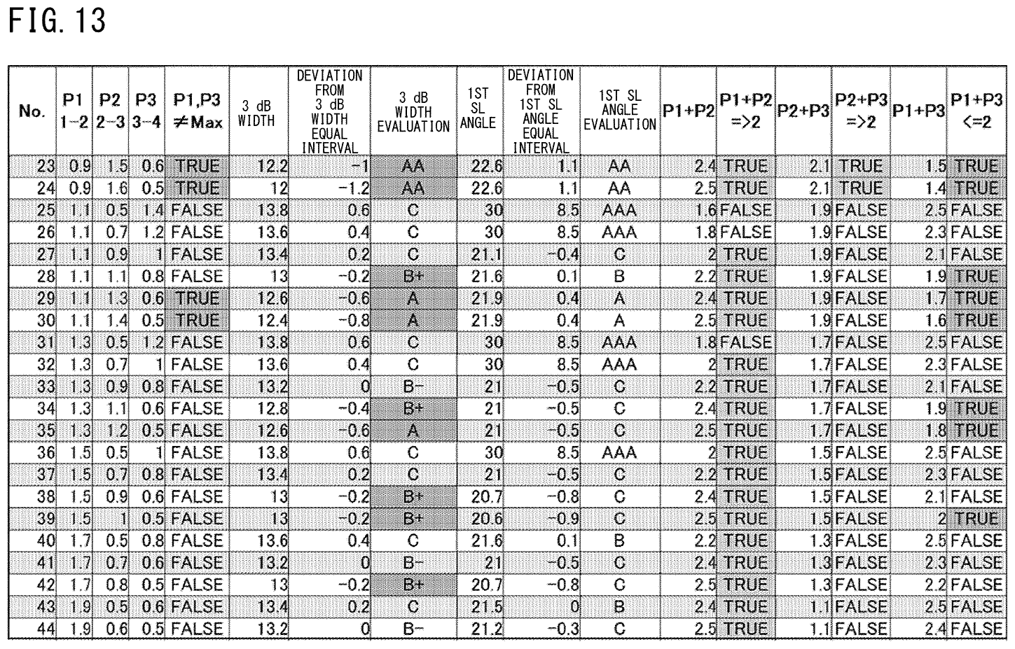

FIGS. 12 and 13 show the results of the first experiment. In FIGS. 12 and 13, “No.” and “P1”, “P2” and “P3” correspond to those in FIGS. 10 and 11. In FIGS. 12 and 13, “P1+P3<=2”, “P1+P2=>2”, and “P2+P3=>2” indicate the conditions of “P1+P3≤2 λ₀”, “P1+P2≥2 λ₀”, and “P2+P3≥2 λ₀” respectively, and whether or not each condition is satisfied is indicated for each of No. 1 to No. 44. If the condition is satisfied, it is indicated by “TRUE”, and if the condition is not satisfied, it is indicated by “FALSE”.

In FIGS. 12 and 13, “3 dB width” indicates the 3 dB beam width obtained for each of No. 1 to No. 44, and the unit is [° ]. In FIGS. 12 and 13, “Deviation from 3 dB width equal interval” indicates deviation from 3 dB beam width (13.2°) in the equal interval arrangement having same interval average P_{AVG} (see FIG. 4), and the unit is [° ]. A negative value of the “Deviation from 3 dB width equal interval” indicates that the angle of the 3 dB beam width is narrowed, and a positive value of the “Deviation from 3 dB width equal interval” indicates that the angle of the 3 dB beam width is widened.

In FIGS. 12 and 13, “3 dB width evaluation” indicates the evaluation of “Deviation from 3 dB width equal interval” obtained for each of No. 1 to No. 44. The evaluation criteria are as follows.
AAA: “Deviation from 3 dB width equal interval” is −1.5° or less.
AA: “Deviation from 3 dB width equal interval” is in a range of −1.4° to −1.0°.
A: “Deviation from 3 dB width equal interval” is in a range of −0.9° to −0.5°.
B+: “Deviation from 3 dB width equal interval” is in a range of −0.4° to −0.2°.
B−: “Deviation from 3 dB width equal interval” is in a range of −0.1° to 0°.
C: “Deviation from 3 dB width equal interval” is greater than 0.

In FIGS. 12 and 13, “1st SL, angle” indicates the first side lobe angle obtained for each of No. 1 to No. 44, and the unit is [° ]. In FIGS. 12 and 13, “Deviation from 1st SL equal interval” indicates the deviation from the first side lobe angle (21.5°) in the equal interval arrangement (see FIG. 4) having the same interval average P_{AVG}, and the unit is [° ]. If the “Deviation from 1st SL equal interval” is a positive value, it indicates that the first side lobe is outwardly angled, and if it is a negative value, it indicates that the first side lobe is inwardly angled.

In FIGS. 12 and 13. “1st angle evaluation” indicates evaluation of “Deviation from 1st SL equal interval” obtained for each of No. 1 to No. 44. The evaluation criteria are as follows.
AAA: “Deviation from 1st SL equal interval” is 1° or more.
AA: “Deviation from 1st SL equal interval” is in a range of 0.5° to 0.9°.
A: “Deviation from 1st SL equal interval” is in a range of 0.2° to 0.4°.
B: “Deviation from 1st SL equal interval” is in a range of 0° to 0.1°.
C: “Deviation from 1st SL equal interval” is less than 0.

In FIGS. 12 and 13, “P1+P2”, “P2+P3”, and “P1+P3” represent the sum of P1 and P2, the sum of P2 and P3, and the sum of P1 and P3, respectively. The unit is [e mini]. For example, if P1+P2 is 1, it indicates that P1+P2 is 1 λ₀.

In FIGS. 12 and 13, when [P1+P3]=[P_{L}+P_{R}] is 2 or less, that is, P_{L}+P_{R}≤P_{AVG}×2 holds in No. 4-9, 13-17, 21-24, 28-30, 34, 35, 39. When [P1+P3]=[P_{L}+P_{R}] is 2 or less, all the “3 dB width evaluation” are B+ or more, and widening the angle of the main lobe is prevented.

In FIGS. 12 and 13, when [P1+P2]≥2 λ₀ and [P2+P3]≥2 λ₀, that is, P_{L}+P_{M}≥P_{AVG}×2 and P_{M}+P_{R}≥P_{AVG}×2, holds in No. 6-9, 14-17, 21-24. In these cases, the “1st SL angle evaluation” are B or more in all cases, and in addition to the prevention of the wide angle of the main lobe, the outward angle of the first side lobe can also be achieved.

[Second Experiment: Five Antenna Elements]

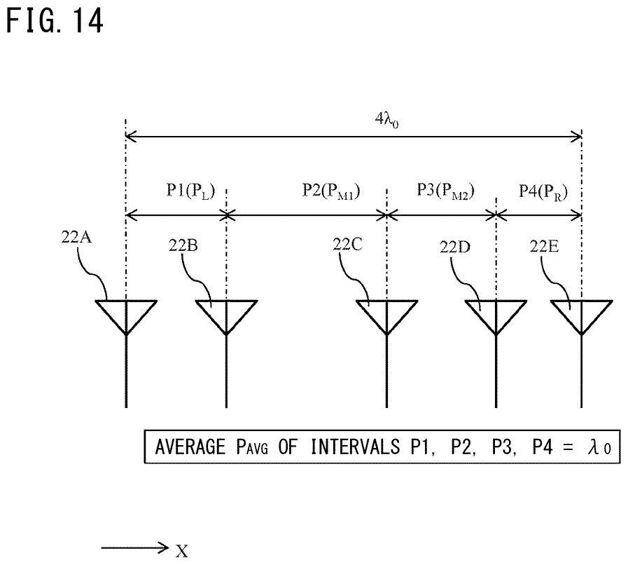

In the second experiment, intervals P1, P2, P3, and P4 in radar antenna 22 having five antenna elements 22A, 22B, 22C, 22D, and 22E arranged along the X direction (first direction) as shown in FIG. 14 were changed to various values, and the 3 dB beam width and the first side lobe angle were obtained by directivity composite calculation using a point wave source.

In the case of FIG. 14, the first end antenna element is antenna element 22A and the second end antenna element is antenna element 22E.

Antenna elements 22B, 22C, and 22D positioned between first end antenna element 22A and second end antenna element 22E are also referred to as intermediate antenna elements. Here, among three intermediate antenna elements 22B, 22C, and 22D, antenna element 22B is referred to as a first intermediate antenna element, antenna element 22C is referred to as a second intermediate antenna element, and antenna element 22D is referred to as a third intermediate antenna element. It is assumed that an interval between antenna element 22A and antenna element 22B is P1, an interval between antenna element 22B and antenna element 22C is P2, an interval between antenna element 22C and antenna element 22D is P3, and an interval between antenna element 22D and antenna element 22E is P4.

An interval between first end antenna element 22A and first intermediate antenna element 22B is referred to as first end interval P1. Aforementioned interval P1 is also first end interval P_{L}. An interval between second end antenna element 22E and third intermediate antenna element 22D is referred to as second end interval P_{R}. Aforementioned interval P4 is also second end interval P_{R}. An interval between first intermediate antenna element 22B and second intermediate antenna element 22C is referred to as a first intermediate interval P_{M1}. Aforementioned interval P2 is also first intermediate interval P_{M1}. An interval between second intermediate antenna element 22C and third intermediate antenna element 22D is referred to as a second intermediate interval P_{M2}. Aforementioned interval P3 is also second intermediate interval P_{M2}.

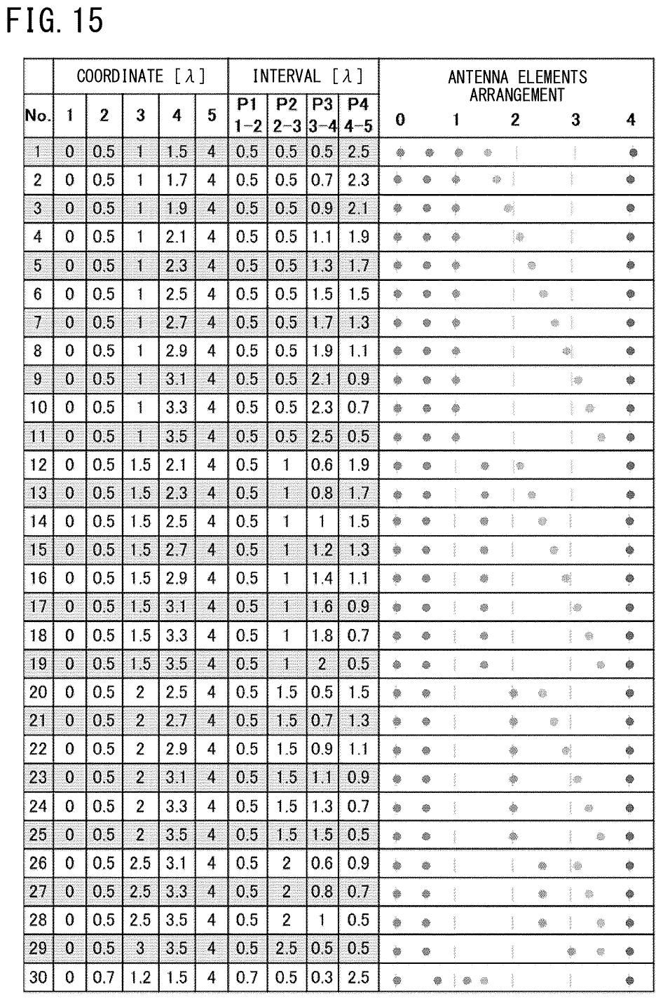

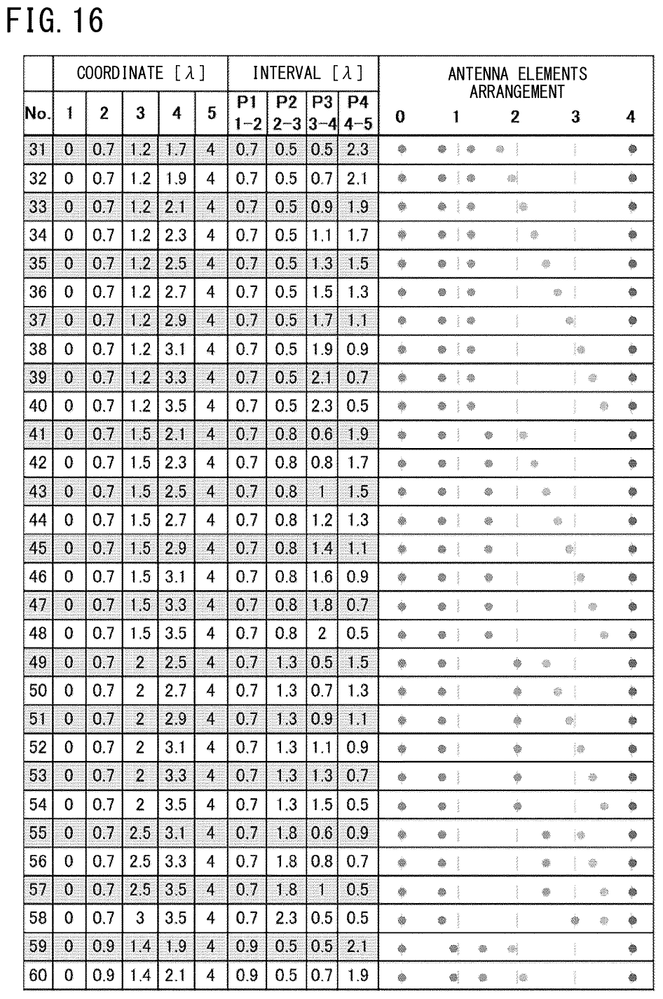

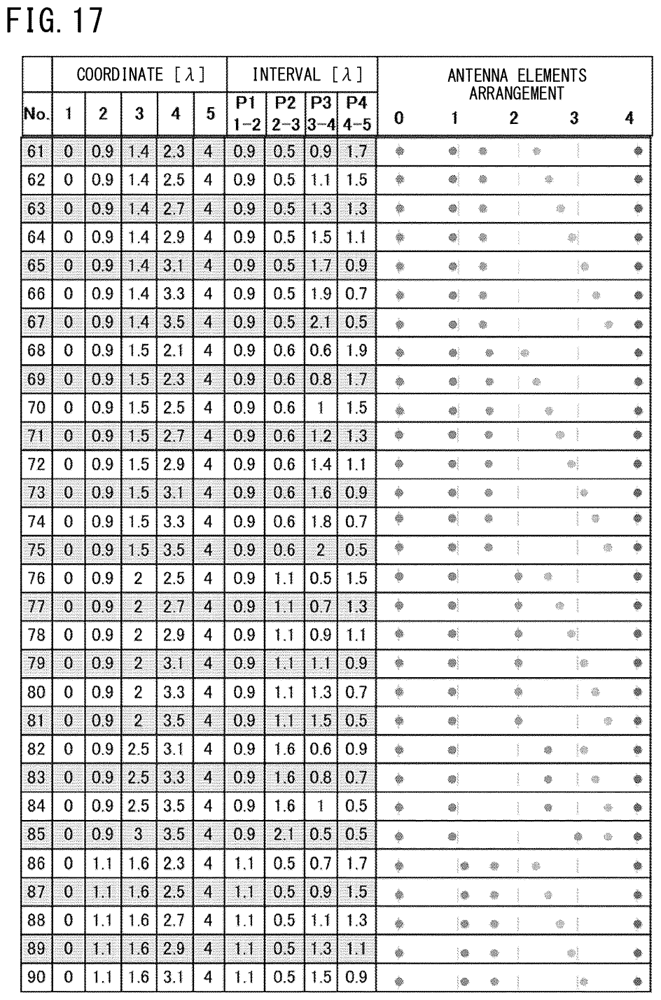

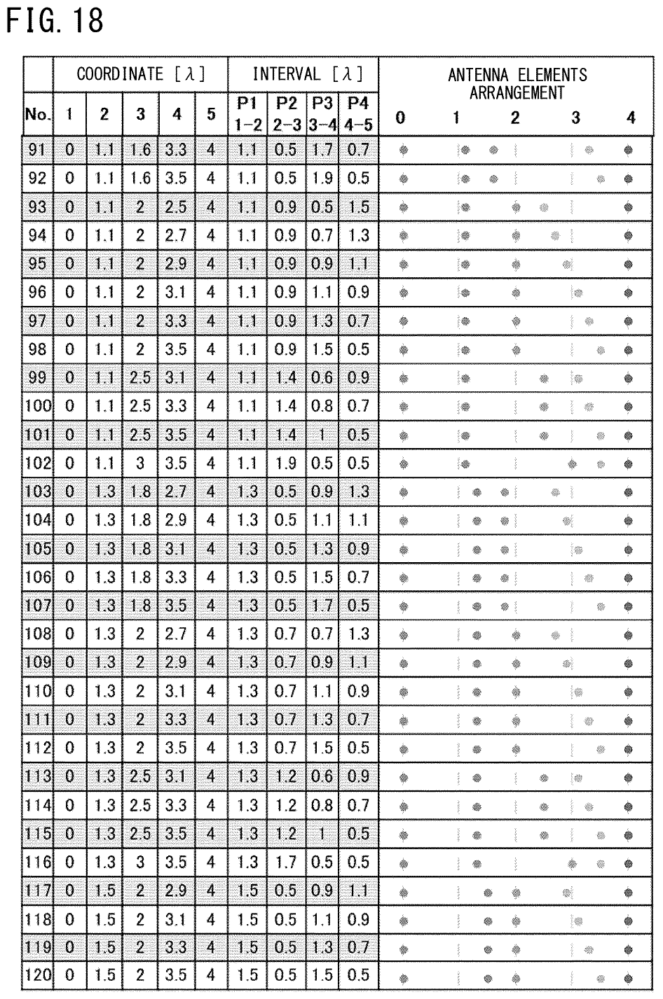

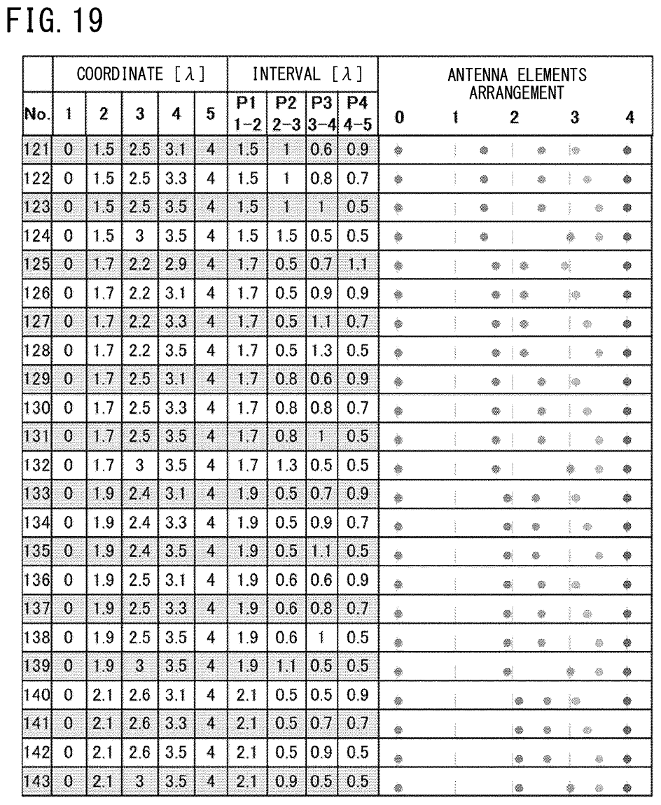

In the second experiment, the 3 dB beam width and the first side lobe angle were obtained for each of 143 combinations of P1, P2, P3, and P4 (No. 1 to No. 143 in FIGS. 15 to 19). The notation of FIGS. 15 to 19 is the same as that of FIGS. 10 and 11 except that the number of antenna elements is different.

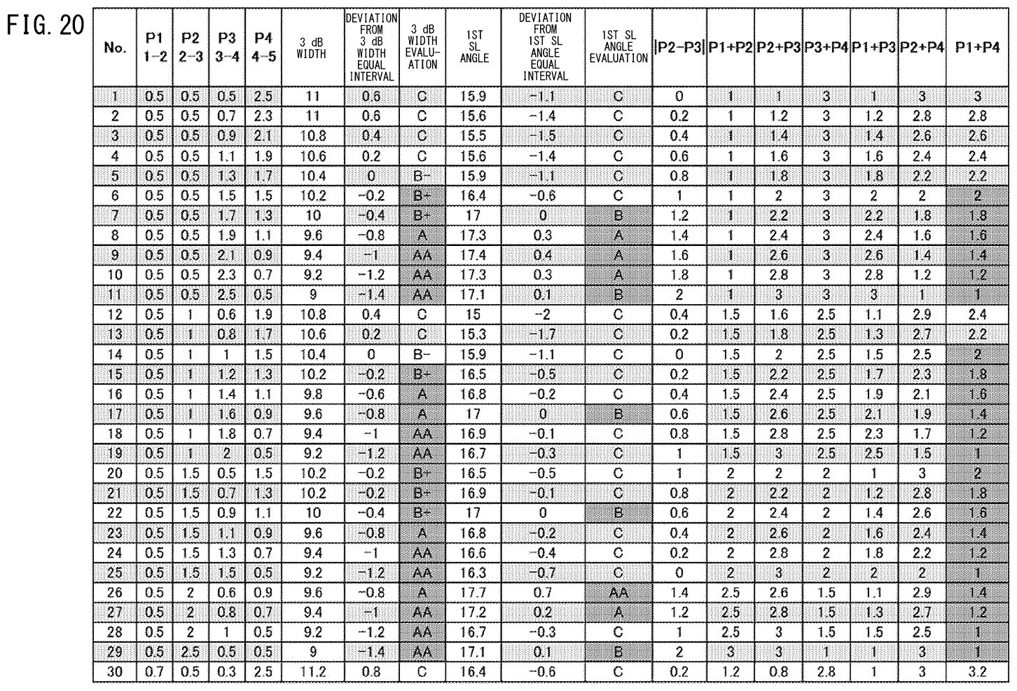

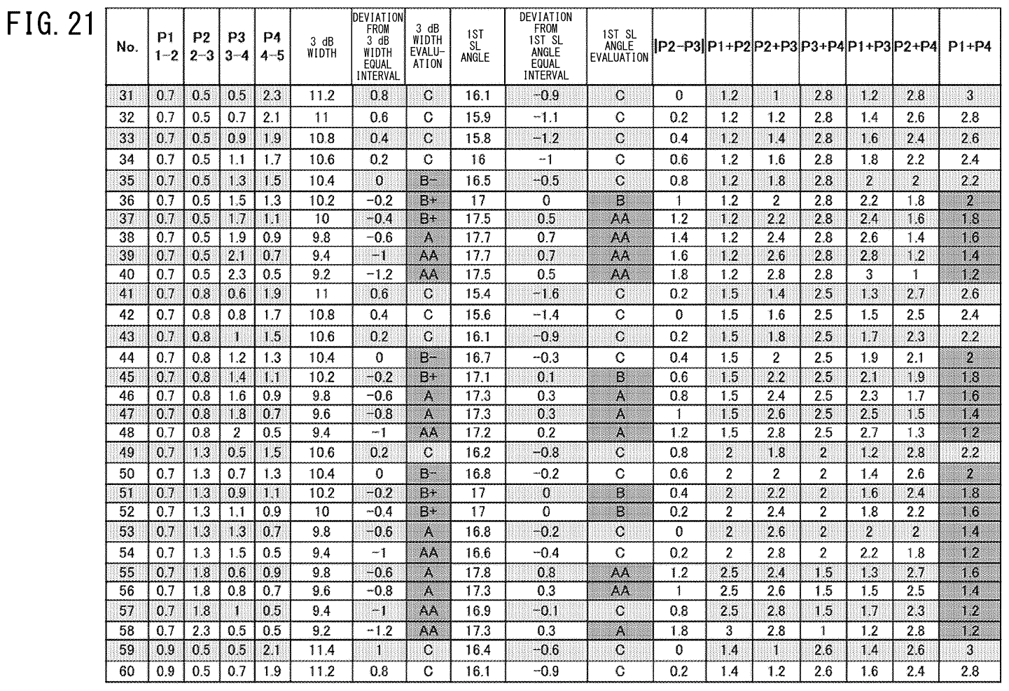

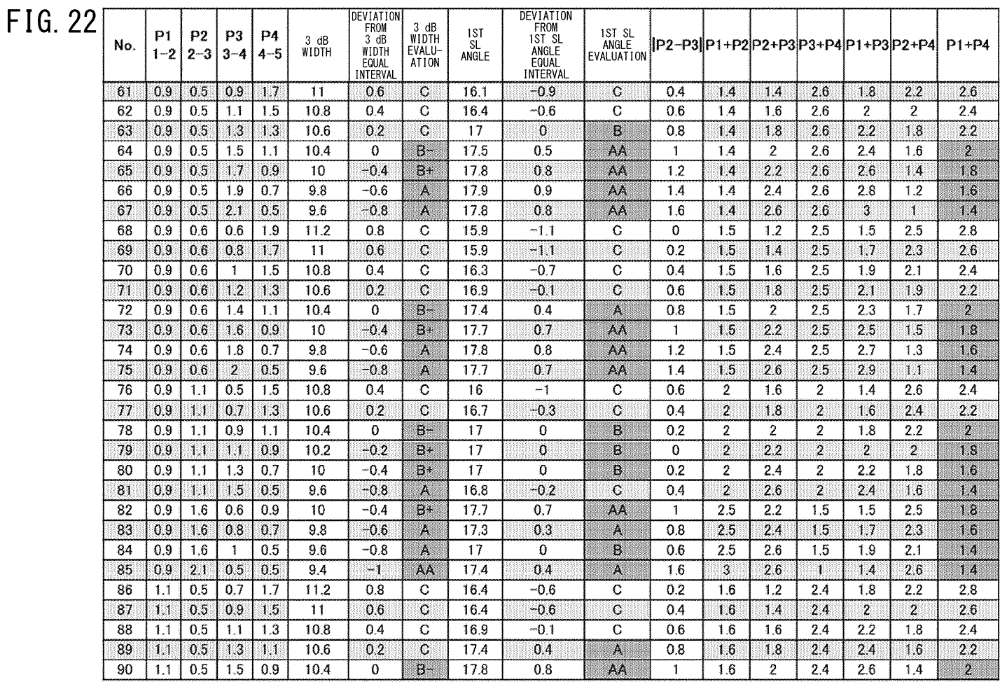

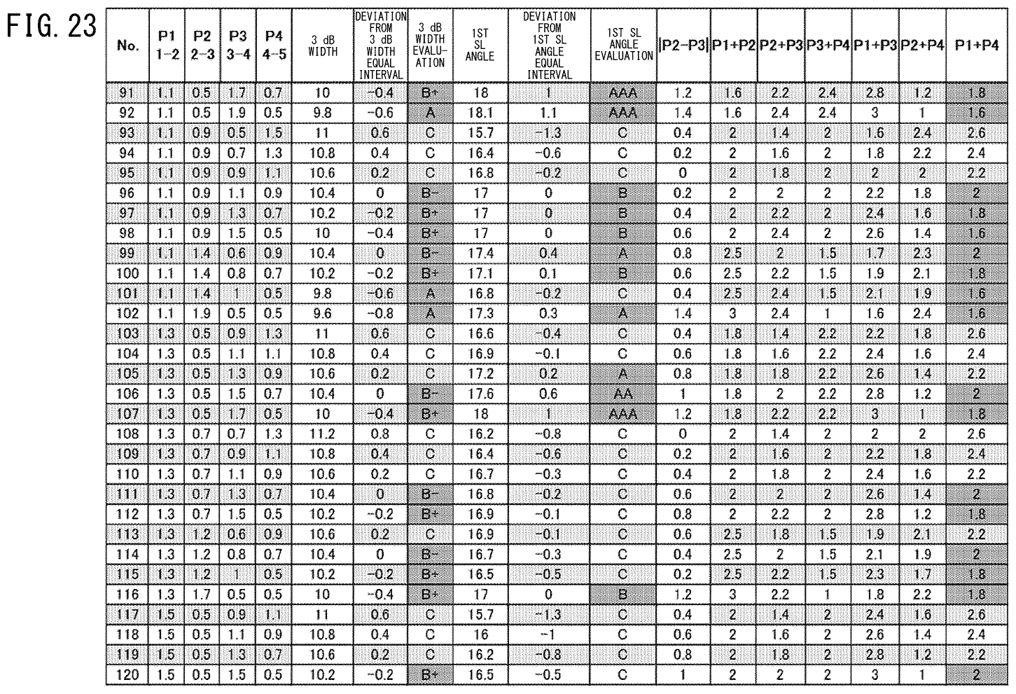

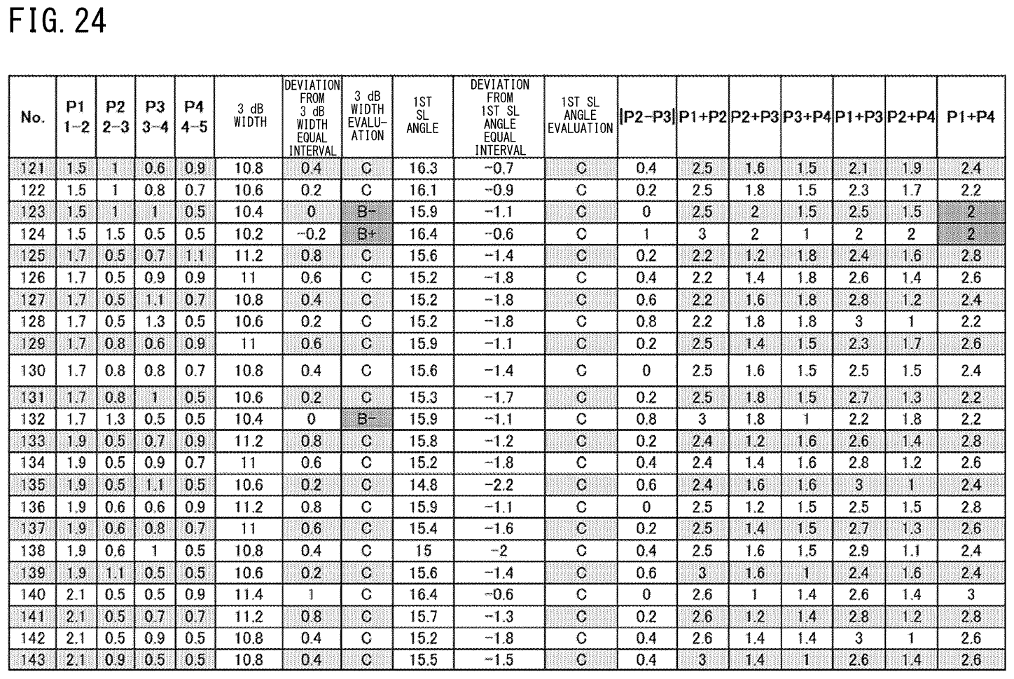

FIGS. 20 to 24 show the results of the second experiment. In FIGS. 20 to 24, “No.” and “P1” “P2” “P3”, and “P4” correspond to those in FIGS. 15 to 19. In FIGS. 20 to 24, “3 dB width”, “Deviation from 3 dB width equal interval”, “3 dB width evaluation”, “1st SL angle”, “Deviation from 1st SL equal interval”, and “1st angle evaluation” are the same as in FIGS. 12 and 13.

In FIGS. 20 to 24, [|P2−P3|][P1+P][P2+P3|][P3+P4][P1+P3][P2+P4][P1+P4] represent the absolute value of the difference between P2 and P3, the sum of P1 and P2, the sum of P2 and P3, the sum of P3 and P4, the sum of P1 and P3, the sum of P2 and P4, and the sum of P1 and P4, respectively. The unit is [λ₀ mm], respectively.

In FIGS. 20 to 24, when [P1+P4]=[P_{L}+P_{R}] is 2 or less, that is, P_{L}+P_{R}≤P_{AVG}×2 holds in No. 6-11, 14-29, 36-40, 44-48, 50-58, 64-67,72-75, 78-85, 90-92, 96-102, 106-107, 111-112, 114, 116, 120, 123-124. In these cases, “3 dB width evaluation” is B+ or more in all cases, and widening the angle of the main lobe is prevented.

Similarly, even when the number of antenna elements constituting array antenna 22 is six, seven, eight, or more, if P_{L}+P_{R}≤P_{AVG}×2 holds, widening the angle of the main lobe is prevented.

### Second Embodiment

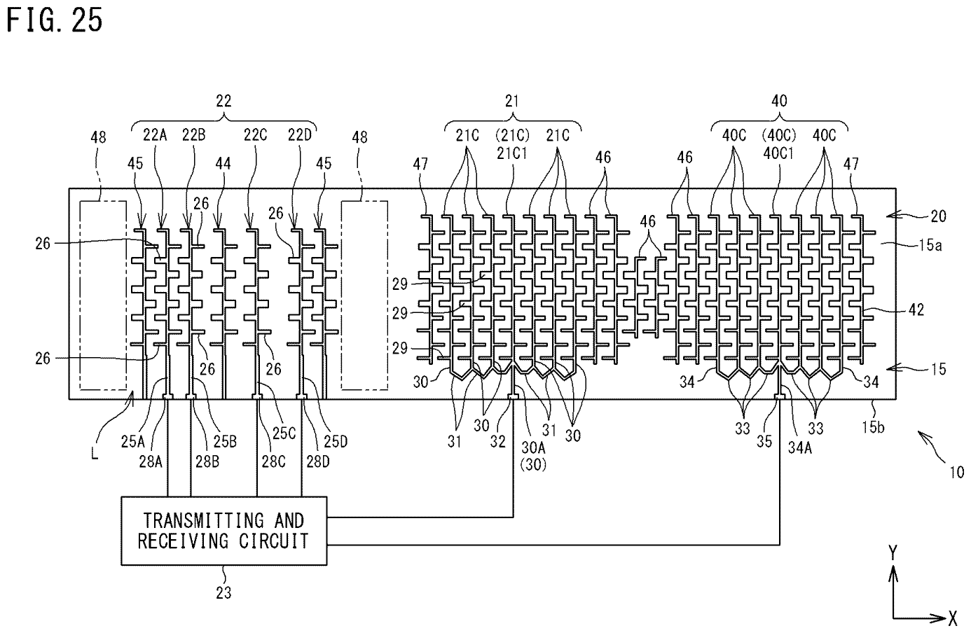

FIG. 25 is a diagram showing a configuration of radar 10 according to the second embodiment.

In FIG. 25, signal processing circuit 24 (FIG. 1) is omitted. In FIG. 25, radar antenna unit 20 is shown as a plan view in the X-Y plane.

Radar antenna unit 20 of radar 10 in the embodiment of the present disclosure includes receiving antenna 22, transmitting antenna 21, a transmitting antenna 40, and substrate 15. In other words, radar 10 in the embodiment of the present disclosure differs from the first embodiment in that it includes a pair of transmitting antennas.

Antennas 21, 22, and 40 are provided on substrate 15. Substrate 15 has a rectangular shape. The long side of substrate 15 is parallel to the X direction. The short side of substrate 15 is parallel to the Y direction. Antenna elements 22A, 22B, 22C, and 22D of receiving antenna 22 and the pair of transmitting antennas 21 and 40 are disposed in a row along the X direction.

Receiving antenna 22 of the embodiment of the present disclosure includes antenna elements 22A, 22B, 22C, and 22D, as described above. Antenna elements 22A, 22B, 22C, and 22D are provided on one surface 15a of substrate 15.

Antenna element 22A includes a larger number of patch elements 26 than in the first embodiment. A plurality of (nine in the illustrated example) patch elements 26 are connected in a direct row by feeder line 25A.

In FIG. 25, nine patch elements 26 included in antenna element 22A are provided along the Y direction (feeder line 25A) at regular intervals. The interval between the plurality of patch elements 26 is one half of the preset design wavelength. The plurality of patch elements 26 include patch element 26 extending to one side in the X direction with respect to feeder line 25A and patch element 26 extending to the other side in the X direction. Patch elements 26 extending to one side in the X direction and patch elements 26 extending to the other side in the X direction are alternately disposed along the Y direction.

The size (area) of patch element 26 disposed in the central region in the Y direction among the plurality of patch elements 26 of antenna element 22A is larger than the sizes of other patch elements 26. In other words, the size of patch element 26 decreases with distance from the central region in the Y direction. Thus, the directivity of antenna element 22A to the front side (Z-direction side) is enhanced.

Antenna elements 22B, 22C, and 22D also have the same shape as antenna element 22A.

Feeder lines 25A, 25B 25C, and 25D of antenna elements 22A, 22B, 22C, and 221D extend parallel to the Y direction.

Antenna elements 22A, 22B. 22C, and 22D are arranged in rows at intervals so as to form row L along the X direction.

Feeder lines 25A, 25B, 25C, and 25D have receiving points 28A, 28B, 28C, and 28D.

Feeder lines 25A, 25B, 25C, and 25D extend to an edge 15h on one long side of substrate 15. Receiving points 28A, 28B 28C, and 28D are provided on edge 15b on one long side of substrate 15.

Receiving points 28A, 28B, 28C, 28D are connected to transmitting and receiving circuit 23. Accordingly antenna elements 22A, 22B, 22C, and 22D are connected to transmitting and receiving circuit 23.

As described above, radar antenna unit 20 has receiving points 28A, 28B, 28C, and 28D corresponding to antenna elements 22A, 22B, 22C, and 22D, and has four receiving systems.

Like receiving antenna 22, transmitting antenna 21 is constituted by a conductor pattern provided on one surface 15a of substrate 15. Transmitting antenna 21 includes a plurality of (seven in the illustrated example) antenna elements 21C.

Each antenna element 21C includes a plurality of patch elements 29 and a feeder line 30. The plurality of (eleven in the illustrated example) patch elements 29 are connected in a straight row by feeder lines 30. Feeder line 30 extends along the Y direction. Feeder lines 30 are provided at equal intervals in the X direction. Therefore, seven antenna elements 21C are provided at equal intervals in the X direction.

The plurality of patch elements 29 are provided along the Y direction at regular intervals. The interval between the plurality of patch elements 29 is one half of the design wavelength. The plurality of patch elements 29 include patch element 29 extending to one side in the X direction with respect to feeder line 30 and patch element 29 extending to the other side in the X direction. Patch elements 29 extending to one side in the X direction and patch elements 29 extending to the other side in the X direction are alternately disposed along the Y direction.

Among the plurality of patch elements 29 of antenna element 21C, patch element 29 disposed substantially at the center in the Y direction has a larger size (area) than other patch elements 29. That is, the size of patch element 29 decreases as the distance from the center in the Y direction increases. Thus, the directivity of antenna element 21C to the front side (Z-direction side) is enhanced.

An antenna element 21C1 is antenna element 21C positioned at the center in the X direction among seven antenna elements 21C. A feeder line 30A of antenna element 21C1 has a feeding point 32.

Feeder line 30A extends to edge 15b of substrate 15. Feeding point 32 is provided at edge 15b of substrate 15. Feeding point 32 is connected to transmitting and receiving circuit 23. Transmitting antenna 21 further includes a plurality of (six in the illustrated example) connecting paths 31. Each connecting path 31 connects a pair of antenna elements 21C adjacent to each other among seven antenna elements 21C. Each connecting path 31 connects edge 15b side ends of the pair of feeder lines 30 of the pair of antenna elements 21C to each other. The length of connecting path 31 is the same as the design wavelength. Accordingly, seven antenna elements 21C are connected to transmitting and receiving circuit 23.

A signal transmitted as a radar wave from transmitting and receiving circuit 23 is supplied to feeding point 32. The signal supplied to feeding point 32 is radiated as a radar wave from transmitting antenna 21 (seven antenna elements 21C).

Transmitting antenna 40 is provided next to transmitting antenna 21 in the X direction. Transmitting antenna 40 includes a plurality of (seven in the illustrated example) antenna elements 40C and a plurality of (six in the illustrated example) connecting paths 33.

Transmitting antenna 40 has the same configuration as transmitting antenna 21. Therefore, each antenna element 40C has the same shape as antenna element 21C. In addition, each connecting path 33 connects a pair of antenna elements 40C adjacent to each other among seven antenna elements 40C. Each connecting path 33 connects a feeding point 35 side ends of the pair of feeder lines 34 of the pair of antenna elements 40C to each other.

An antenna element 40C1 is antenna element 40C positioned at the center in the X direction among seven antenna elements 40C. A feeder line 34A of antenna element 40C1 has feeding point 35.

Feeder line 34A extends to edge 15b of substrate 15. Feeding point 35 is provided at edge 15b of substrate 15. Feeding point 35 is connected to transmitting and receiving circuit 23. Accordingly, seven antenna elements 40C are connected to transmitting and receiving circuit 23.

A signal transmitted as a radar wave from transmitting and receiving circuit 23 is supplied to feeding point 35. The signal supplied to feeding point 35 is radiated as a radar wave from transmitting antenna 40 (seven antenna elements 40C).

As described above, radar antenna unit 20 has feeding point 32 of transmitting antenna 21 and feeding point 35 of transmitting antenna 40, and has two transmission systems.

Parasitic elements 44, 45, 46 and 47 are provided on one surface 15a of substrate 15. Parasitic element 44 is provided between antenna elements 22B and 22C. Parasitic element 45 is provided on the outer side of receiving antenna 22 in the X direction.

Parasitic element 46 is provided between transmitting antenna 21 and transmitting antenna 40. Parasitic element 47 is provided on the outer side of transmitting antenna 21 and transmitting antenna 40 in the X direction.

Substrate 15 is also provided with a pair of shield portions 48. The pair of shield portions 48 are provided on both sides of receiving antenna 22 in the X direction. Shield portion 48 is constituted by a large number of through holes or the like. Shield portion 48 prevents the radar waves radiated by transmitting antenna 21 and transmitting antenna 40 from entering receiving antenna 22.

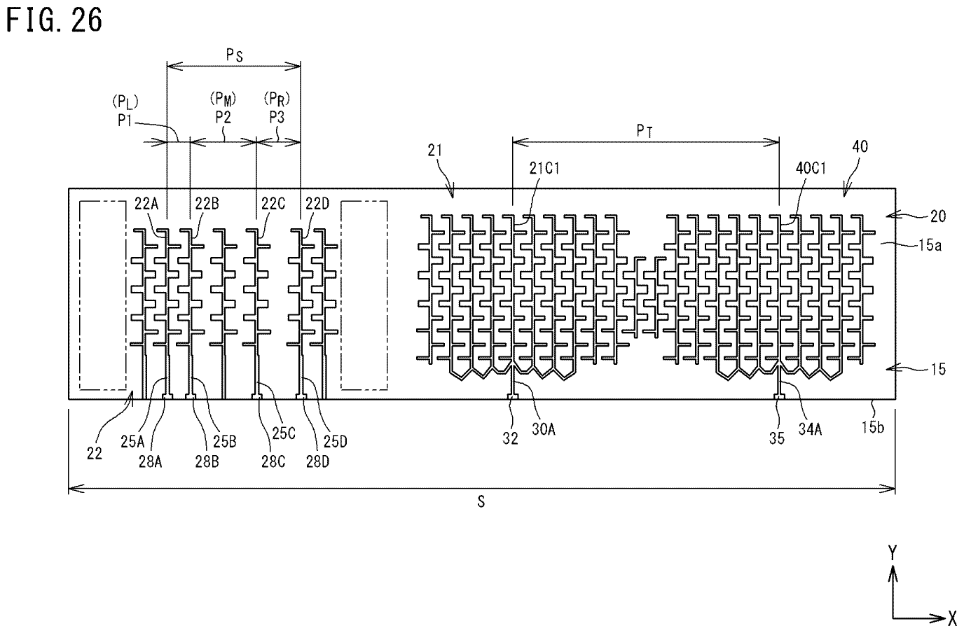

FIG. 26 is a plan view of radar antenna unit 20 showing the positional relationship of each antenna in the X direction. In FIG. 26, radar antenna unit 20 is represented as a plan view in the X-Y plane.

Also in the embodiment of the present disclosure, as in the first embodiment, intervals P1, P2, and P3 (first end interval P_{L}, intermediate interval P_{M}, and second end interval P_{R}) of the plurality of antenna elements 22A, 22B, 22C, and 22I) included in receiving antenna 22 are unequal intervals.

That is, at least one interval among the plurality of intervals P1, P2, and P3 between the plurality of antenna elements 22A, 22B, 22C, and 22D included in receiving antenna 22 is different from the other intervals.

Intervals P1, P2, P3 of the embodiment of the present disclosure are all different from each other. More specifically, interval P1 is 0.55 λ₀, interval P2 is 1.65 λ₀, and interval P3 is 1.1 λ₀.

A distance P_{S} between first end antenna element 22A and second end antenna element 22D is 3.3 λ₀. Also, interval average P_{AVG} is 1.1 λ₀.

Thus, in the embodiment of the present disclosure, the plurality of antenna elements 22A, 22B, 22C, and 22D are disposed such that P_{L}±P_{R}≤P_{AVG}×2 holds and P_{AVG} is from 0.8 λ₀ to 1.2 λ₀.

Also, an interval P_{T} between transmitting antenna 21 and transmitting antenna 40 is 6.6 λ₀.

Thus, in the embodiment of the present disclosure, interval P_{T} between transmitting antenna 21 and transmitting antenna 40 is greater than distance P_{S} between first end antenna element 22A and second end antenna element 22D.

Note that interval P_{T} is the length along the X direction between the center of transmitting antenna 21 in the X direction and transmitting antenna 40. More specifically, it is the length along the X direction from the center in the X direction of antenna element 21C1 included in transmitting antenna 21 to the center in the X direction of antenna element 40C1 included in transmitting antenna 40.

Transmitting and receiving circuit 23 of radar 10 configured as described above generates a signal to be radiated as a radio wave (radar wave) by transmitting antenna 21 and transmitting antenna 40.

The signal radiated as a radio wave is a frequency modulated continuous wave as described above. More specifically, a signal that is a frequency modulated continuous wave is a signal in which chirp signals are temporally continuously arranged. The chirp signal is a signal whose frequency increases or decreases within a predetermined frequency bandwidth over time.

The frequency bandwidth of the chirp signal is determined within a range from 30 GHz to 300 GHz.

The temporally continuous chirp signal is supplied to feeding points 32, 35 of radar antenna unit 20 and is radiated as radio waves by transmitting antenna 21 and transmitting antenna 40.

The same signal is supplied to both feeding point 32 and feeding point 35. Therefore, transmitting antenna 21 and transmitting antenna 40 both radiate the same radio wave. “Temporally continuous chirp signals are the same” means that the chirp signals have the same waveform and are in phase (the timing of each continuous chirp signal is the same).

The radio waves radiated by transmitting antenna 21 and transmitting antenna 40 are reflected by an object such as a vehicle.

Receiving antenna 22 receives a reflected wave of a radio wave reflected by the object. The reflected wave received by receiving antenna 22 is provided to transmitting and receiving circuit 23 as a reflected wave signal via receiving points 28A, 28B 28C, and 28D. That is, transmitting and receiving circuit 23 is provided with the reflected wave signals received by the plurality of antenna elements 22A, 22B, 22C, and 22D disposed at unequal intervals in the X direction.

Transmitting and receiving circuit 23 provides the reflected wave signals received by the plurality of antenna elements 22A, 22B, 22C and 22D to signal processing circuit 24 (FIG. 1).

Signal processing circuit 24 performs a process of detecting a distance, a direction, a speed, and the like to the object based on the reflected wave signal received by antenna element 22A, the reflected wave signal received by antenna element 22B, the reflected wave signal received by antenna element 22C, and the reflected wave signal received by antenna element 22D.

Signal processing circuit 24 estimates the arrival direction of the reflected wave received by receiving antenna 22 and acquires information on the reflection point of the reflected wave. The information of the reflection point includes position information (coordinates and the like) of the reflection point. Signal processing circuit 24 recognizes the object based on the information of the reflection point. Further, radar 10 recognizes the position and the speed of the object based on the information of the reflection point.

Here, in the embodiment of the present disclosure, the radar wave is radiated from each of the pair of transmitting antennas 21, 40. A pair of radar waves radiated from the pair of transmitting antennas 21, 40 are reflected by the object. Thus, the signal received by receiving antenna 22 includes a pair of reflected wave signals corresponding to the pair of radar waves.

Interval P_{T} of the pair of transmitting antennas 21, 40 is greater than distance P_{S} between first end antenna element 22A and second end antenna element 22D Therefore, it is possible to easily separate and acquire the pair of reflected wave signals from signals received by antenna elements 22A, 22B, 22C, and 22D. That is, the reflected wave signal corresponding to the radar wave radiated from transmitting antenna 21 and the reflected wave signal corresponding to the radar wave radiated from transmitting antenna 40 can be easily separated and acquired from the signals received by antenna elements 22A, 22B 22C, and 22D. As a result, it is possible to obtain the same number of reflected wave signals as in the case of reception by twice the number of receiving antenna elements (four in the embodiment of the present disclosure) of receiving antenna 22.

In other words, by virtually increasing the number of receiving antenna elements to two times (eight), more reflected wave signals can be obtained than in the case where a radar wave is radiated from one transmitting antenna. Thus, in the embodiment of the present disclosure, receiving antenna 22 having four receiving systems (four receiving antenna elements) can be used as if it had eight receiving systems (eight receiving antenna elements), and the widening the angle of the main lobe can be prevented more effectively.

Interval P_{T} between the pair of transmitting antennas 21, 40 is equal to or less than an upper limit U determined based on a width S of substrate 15 in the X direction and distance P_{S} between first end antenna element 22A and second end antenna element 22D.

Upper limit U may be, for example, a value obtained by subtracting distance P_{S} from width S of substrate 15 in the X direction. As a result, interval P_{T} between the pair of transmitting antennas 21, 40 is limited, and an increase in the size of the entire unit can be suppressed.

In the embodiment of the present disclosure, the case where the same signal (temporally continuous chirp signal) is given to feeding point 32 and feeding point 35 is shown, but different signals may be given to feeding point 32 and feeding point 35. The case where the signals are different from each other includes the case where the waveform of the chirp signal is different, the case where the phase is different (the timing of each chirp signal is different), and the like.

In this case, the pair of reflected wave signals can be more easily separated and obtained from the signal received by receiving antenna 22.

Although k, is the free space wavelength of the radio waves transmitted and received by radar 10 in the above embodiments, λ₀ may be a wavelength corresponding to a predetermined frequency within the frequency bandwidth of the radar waves radiated from transmitting antennas 21 and 40.

Next, an experiment using radar 10 of the second embodiment will be described.

### [Third Experiment]

In the third experiment, radars according to an experimental product 1 and an experimental product 2 described below were installed on a road, and recognition ability was evaluated when a vehicle traveling on the road was actually detected.

That is, the experiment was performed on the case where the radar wave was transmitted using a pair of transmitting antennas in the experimental product 1, and the experiment was performed on the case where the radar wave was transmitted using one transmitting antenna in the experimental product 2.
Experimental product 1: radar 10 of the second embodiment
Experimental product 2: radar 10 of the second embodiment configured to radiate the radar wave only from transmitting antenna 21.

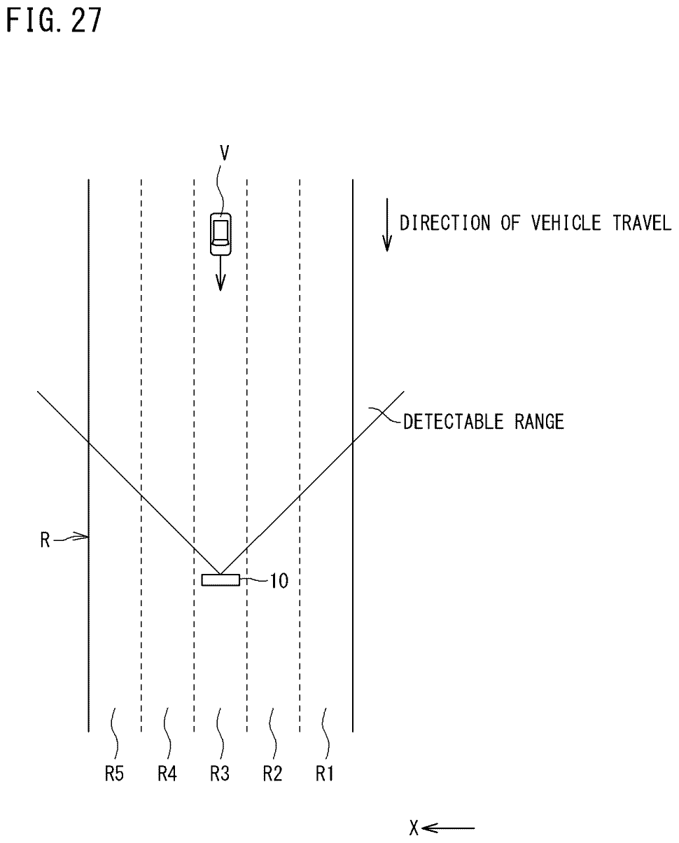

FIG. 27 is a plan view of a road on which a radar 10 installed.

As shown in FIG. 27, radar 10 was installed on a road R of 5 lanes. The detectable range of radar 10 is positioned on the upstream side of road R from the position of radar 10. Therefore, radar 10 detects a vehicle V approaching radar 10 from the upstream side of radar 10.

Road R includes a first lane R1, a second lane R2, a third lane R3, a fourth lane R4, and a fifth lane R5. First lane R1, second lane R2, third lane R3, fourth lane R4 and fifth lane R5 are arranged in order along the width direction of road R from one road side. Radar 10 is disposed above the road surface of third lane R3, for example. Radar 10 was disposed so that the X direction was orthogonal to the extending direction of road R. The depression angle of radar 10 (the angle of the normal line of one surface 15a of substrate 15 with respect to the horizontal direction) was appropriately set in accordance with the performance of the transmitting antenna 21, 40 and receiving antenna 22.

Vehicle V traveling in each lane was detected using radar 10, and the vehicle recognition distance and the lane recognition distance were acquired.

The vehicle recognition distance is a distance from radar 10 to vehicle V and indicates a range on road R in which vehicle V can be recognized by radar 10.

More specifically, vehicle V is caused to travel in only one of the lanes, and radar 10 is caused to recognize vehicle V. Among distances from radar 10 to vehicle V when radar 10 recognizes the presence and the position of vehicle V, the largest distance was set as a vehicle recognition distance. Radar 10 can recognize the presence of vehicle V within a range equal to or less than the vehicle recognition distance.

The lane recognition distance is a distance from radar 10 to vehicle V and indicates a range on road R in which the driving lane of vehicle V can be recognized by radar 10.

More specifically, the lane is determined based on the position of vehicle V recognized by radar 10, and the largest distance among distances from radar 10 to vehicle V when the determination result and the lane in which vehicle V actually travels coincide with each other is set as the lane recognition distance. Radar 10 can recognize the lane in which vehicle V travels within a range equal to or less than the lane recognition distance.

As vehicle V, a large-sized vehicle (for example, a bus, a truck, or the like) was used. The running speed of vehicle V was 80 km/hour. Vehicle V was caused to travel in each lane, and the vehicle recognition distance and the lane recognition distance were acquired for each lane.

The Capon method was used as a method for radar 10 to estimate the direction of arrival of the reflected wave received by receiving antenna 22.

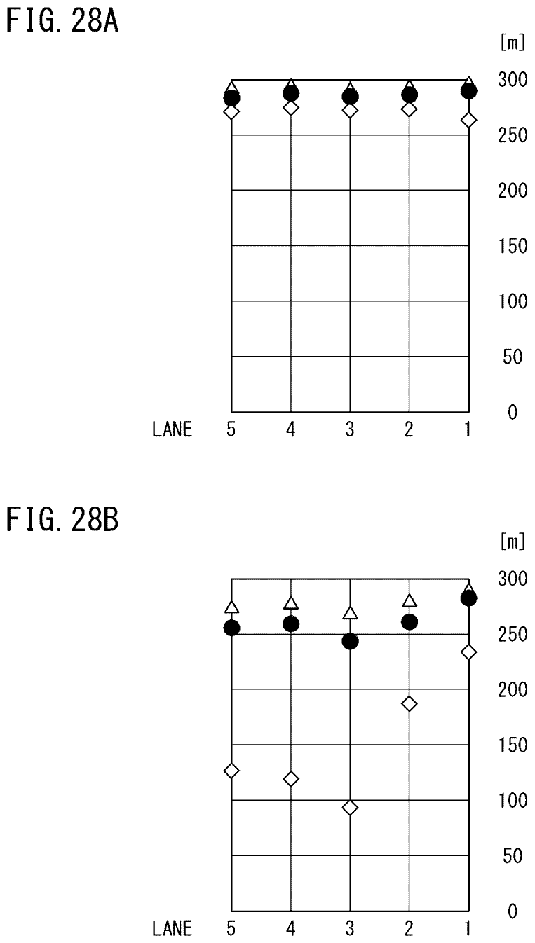

FIG. 28A is a graph showing a result of obtaining a vehicle recognition distance and a lane recognition distance using the experimental product 1, and FIG. 28B is a graph showing a result of obtaining a vehicle recognition distance and a lane recognition distance using the experimental product 2.

In FIGS. 28A and 28B, the horizontal axis represents lane, and the vertical axis represents distance from radar 10 to vehicle V. In FIGS. 28A and 28B, black circles indicate vehicle recognition distances. A white square indicates a lane recognition distance. The white triangle indicates the reflection point acquiring distance.

The reflection point acquiring distance is a distance from radar 10 to the position of the reflection point, and indicates the largest distance among distances from radar 10 to the position of the reflection point estimated by radar 10 to be caused by the reflected wave from vehicle V.

When FIG. 28A (experimental product 1) is compared with FIG. 28B (experimental product 2), it is found that the vehicle recognition distance and the lane recognition distance of the experimental product 1 are larger than the vehicle recognition distance and the lane recognition distance of the experimental product 2 in any of first lane R1 to fifth lane R5.

In addition, the reflection point acquiring distance of the experimental product 1 is also larger than the reflection point acquiring distance of the experimental product 2, From this result, it is understood that when a pair of transmitting antennas is provided as in the experimental product 1, the widening the angle of the main lobe can be more effectively prevented, and the recognition ability of the radar can be further improved.

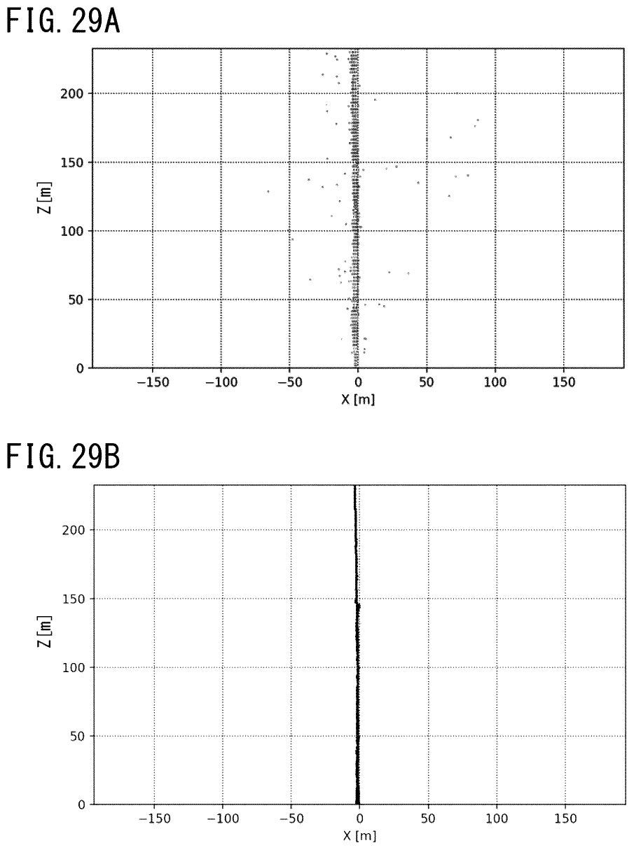

FIG. 29A is a graph plotting positions of vehicles recognized by radar of experimental product 1 when a plurality of vehicles are driven only in the same lane, and FIG. 29B is a graph plotting positions after performing tracking by a kalman filter with respect to the positions in FIG. 29A.

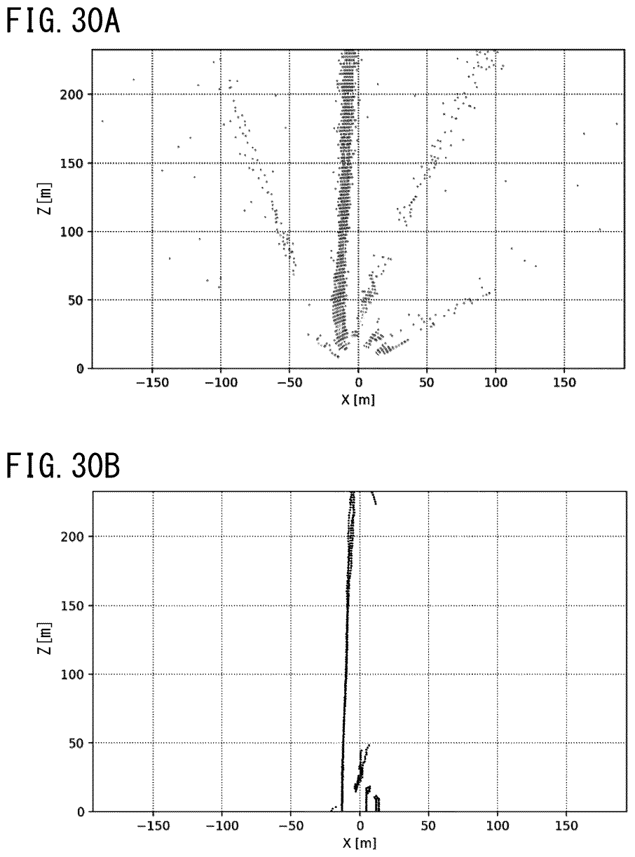

FIG. 30A is a graph plotting positions of vehicles recognized by radar of experimental product 2 when a plurality of vehicles are driven only in the same lane, and FIG. 30B is a graph plotting positions after performing tracking by a kalman filter with respect to the positions in FIG. 30A.

In FIGS. 29A, 29B, 30A, and 30B, the horizontal axis represents the coordinate in the X direction (the width direction of road R), and the vertical axis represents the coordinate in the Z direction (the direction parallel to the extending direction of road R). “0” on the horizontal and vertical axes in FIGS. 29A, 29B, 30A, and 30B indicates the position of radar 10.

FIGS. 29A, FIG. 29B, FIG. 30A and FIG. 30B show the results of running a plurality of vehicles only in third lane R3 in FIG. 27. Therefore, the positions of the vehicles plotted in FIGS. 29A, FIG. 29B, FIG. 30A and FIG. 30B are concentrated at the position of “0” on the horizontal axis.

When FIG. 29A (experimental product 1) is compared with FIG. 30A (experimental product 2), it is found that the variation in the X direction is more suppressed in experimental product 1 than in experimental product 2.

The same applies to FIG. 29B (experimental product 1) and FIG. 30B (experimental product 2), and the variation in the X direction is more suppressed in experimental product 1 than in experimental product 2.

From this result, it can be seen that when a pair of transmitting antennas is provided as in the experimental product 1, the widening the angle of the main lobe can be more effectively prevented, and the recognition ability of the radar can be further improved.

### Third Embodiment

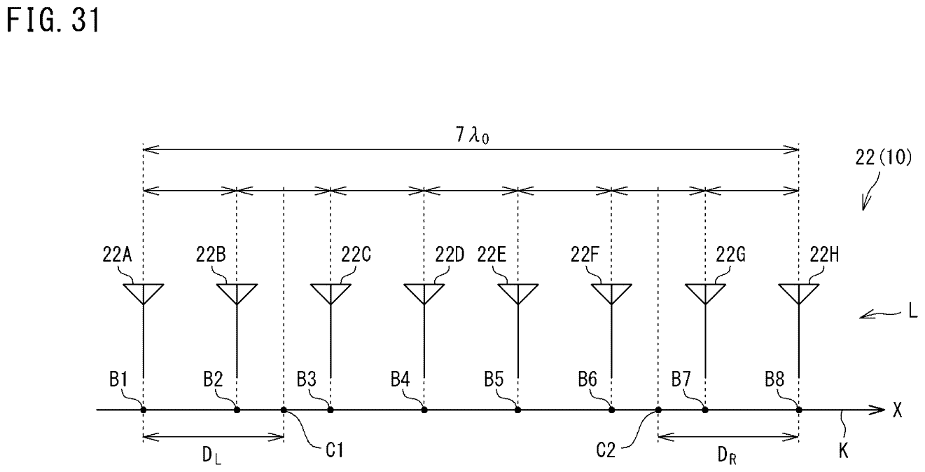

FIG. 31 is a schematic diagram showing an arrangement of receiving antennas 22 of radar 10 according to the third embodiment.

Receiving antenna 22 of the embodiment of the present disclosure includes a plurality of (eight in the illustrated example) antenna elements 22A, 22B, 22C, 22D, 22E, 22F, 22G, and 22f.

Eight antenna elements 22A to 221H are arranged in rows at intervals so as to form row L along the X direction.

These antenna elements 22A to 22H have the same configuration as the antenna elements in the first embodiment. In an embodiment of the present disclosure, the number of antenna elements and the arrangement of the antenna elements are different from the first embodiment.

Among eight antenna elements 22A to 22H, the first end antenna element is antenna element 22A, and the second end antenna element is antenna element 22H. Among eight antenna elements 22A to 22H, antenna elements 22B, 22C, 22D, 22E, 22F, and 22G positioned between first end antenna element 22A and second end antenna element 22H are also referred to as intermediate antenna elements 22B, 22C, 22D, 22E, 22F, and 22G.

Among intermediate antenna elements 22B to 22G, intermediate antenna element 22B positioned next to first end antenna element 22A is also referred to as a first intermediate antenna element 22B.

Among intermediate antenna elements 22B to 22G, intermediate antenna element 22G positioned next to second end antenna element 22H is also referred to as a second intermediate antenna element 22G.

Among intermediate antenna elements antenna elements 223 to 22G, intermediate antenna element 22C positioned next to first intermediate antenna element 22B is also referred to as a third intermediate antenna element 22C. Third intermediate antenna element 22C is positioned on second end antenna element 22H side with respect to first intermediate antenna element 22B.

Further, among intermediate antenna elements 22B to 22G, intermediate antenna element 22F positioned next to second intermediate antenna element 22G is also referred to as a fourth intermediate antenna element 22F. Fourth intermediate antenna element 22F is positioned on first end antenna element 22A side with respect to second intermediate antenna element 22G.

In FIG. 31, points B1 to B8 are points on a straight line K. Straight line K is a straight line parallel to the X direction.

Point B1 indicates a central position of first end antenna element 22A in the X direction. Point B2 indicates a central position of first intermediate antenna element 22B in the X direction. Point B33 indicates a central position of third intermediate antenna element 22C in the X direction. Point B4 indicates a central position of intermediate antenna element 22D in the X direction. Point B5 indicates a central position of intermediate antenna element 22E in the X direction. Point B6 indicates a central position of fourth intermediate antenna element 22F in the X direction. Point B7 indicates a central position of second intermediate antenna element 22G in the X direction. Point B8 indicates a central position of second end antenna element 22H in the X direction.

Between points B1 and 138, there are a plurality of intervals (seven intervals in the illustrated example) such as an interval between point 1 and point B2 and an interval between point B2 and point B3.

At least one interval among the seven intervals between points B1 and B8 is different from the other intervals, That is, at least one interval among the seven intervals between antenna elements 22A to 22H is different from the other intervals. In other words, the intervals of respective antenna elements 22A to 221H are unequal intervals.

As in the first embodiment, in the embodiment of the present disclosure, average P_{AVG} of the seven intervals between antenna elements 22A to 22H is about 1 λ₀. Average P_{AVG} is, as an example, 1 λ₀.

Average P_{AVG} is preferably in the range from 0.8 λ₀ to 1.2 λ₀ as in the first embodiment. The minimum value of the seven intervals between antenna elements 22A to 221H is 0.5 λ₀, as in the above-described embodiment.

When average P_{AVG} is 1 λ₀, the antenna aperture length (length in the X direction) of receiving antenna 22 is 7 λ₀. In this case, the antenna aperture length when eight antenna elements 22A to 22H are disposed at unequal intervals and the antenna aperture length when eight antenna elements 22A to 22H are disposed at equal intervals are the same (7 λ₀).

The antenna aperture length is a distance from point 131 to point B8.

In FIG. 31, a first central position C1 is a point on straight line K parallel to the X direction. First central position C1 is a midpoint between point B2 and point B3. That is, first central position C1 indicates a central position in the X direction between third intermediate antenna element 22C and first intermediate antenna element 22B.

In FIG. 31, a second central position C2 is a point on straight line K parallel to the X direction. Second central position C2 is a midpoint between point B6 and point B7. That is, second central position C2 indicates a central position in the X direction between fourth intermediate antenna element 22F and second intermediate antenna element 22G.

In FIG. 31, a first interval D_{L} is the interval between first central position C1 and point B1. That is, first interval D_{L} is an interval between first central position C1 and first end antenna element 22A in the X direction.

In FIG. 31, a second interval D_{R} is the interval between second central position C2 and point B8. That is, second interval D_{R} is an interval between second central position C2 and second end antenna element 22H in the X direction.

Here, antenna elements 22A to 22H of the embodiment of the present disclosure are disposed such that D_{L}+D_{R}<P_{AVG}×3 holds.

Even when antenna elements 22A to 221H are disposed in this manner, it is possible to prevent the angle of the main lobe from being widened.

Although eight antenna elements 22A to 221H are provided in the embodiment of the present disclosure, the number of antenna elements is preferably six or more. If the number of antenna elements is 5 or less, the condition D_{L}+D_{R}<P_{AVG}×3 cannot be satisfied.

When the number of antenna elements is six or more, widening the angle of the main lobe can be suitably prevented.

Next, an experiment using radar 10 of the third embodiment will be described.

### [Fourth Experiment: Eight Antenna Elements]

In the fourth experiment, first interval D_{L} and second interval D_{R} of receiving antenna 22 (see FIG. 31) having eight antenna elements 22A to 22H arranged along the X direction (first direction) were changed, and the 3 dB beam width was obtained by the directivity composite calculation using a point wave source.

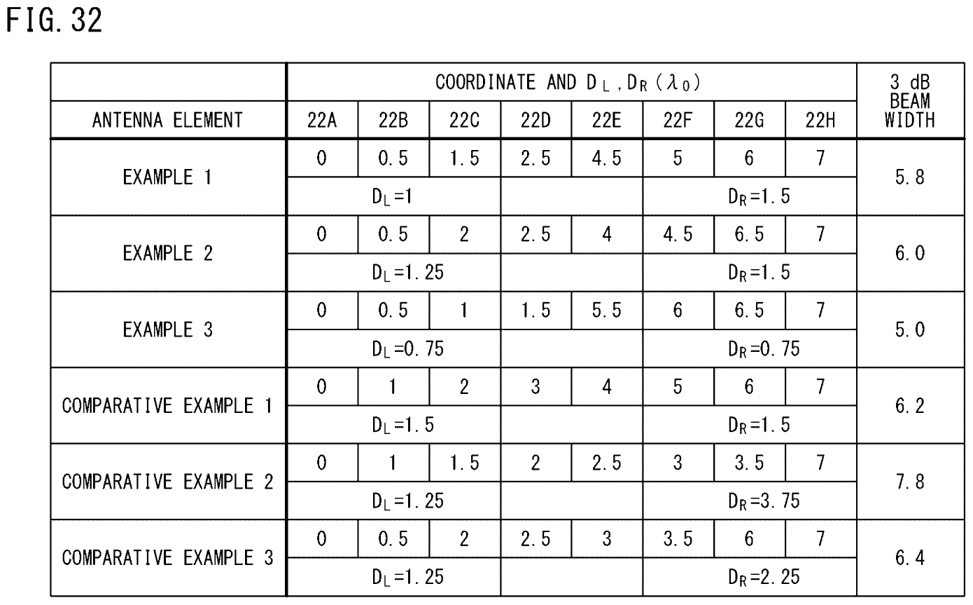

FIG. 32 is a diagram showing an arrangement of antenna elements and a beam width in each of the examples and the comparative examples in the fourth experiment. The coordinates in FIG. 32 indicate the coordinate position of each antenna element in the X direction. The coordinates in FIG. 32 indicate the coordinate position of each antenna element when first end antenna element 22A is set to 0, with λ₀ as one unit. For example, in Example 1, the coordinate of antenna element 22B is 0.5 λ₀, and the coordinate of antenna element 22C is 1.5 λ₀.

In FIG. 32, the unit of the 3 dB beam width is an angle [° ] in the X direction.

In FIG. 32, in Example 1, the antenna elements are arranged such that first interval D_{L} is 1 λ₀ and second interval D_{R} is 1.5 λ₀.

In Example 2, the antenna elements are arranged such that first interval D_{L} is 1.25λ₀ and second interval D_{R} IS 1.5 λ₀.

In Example 3, the antenna elements are arranged such that first interval D_{L} is 0.75 λ₀ and second interval D_{R} is 0.75 λ₀.

Each of these examples satisfies the condition D_{L}+D_{R}<P_{AVG}×3.

In Comparative Example 1, the antenna elements are arranged such that first interval D_{L} is 1.5 λ₀ and second interval D_{R} is 1.5 λ₀. Note that the antenna elements in Comparative Example 1 are in an equal interval arrangement.

In Comparative Example 2, the antenna elements are arranged such that first interval D_{L} is 1.25 λ₀ and second interval D_{R} is 3.75 λ₀.

In Comparative Example 3, the antenna elements are arranged such that first interval D_{L} is 1.25 λ₀ and second interval D_{R} is 2.25 λ₀. Each of these comparative examples does not satisfy the condition D_{L}+D_{R}<P_{AVG}×3.

As shown in FIG. 32, the 3 dB beam widths of Examples 1 to 3 are in the range of 5.0° to 6.0°. On the other hand, the 3 dB beam widths in Comparative Examples 1 to 3 are in the range of 6.2° to 7.8°.

From this result, it can be confirmed that the main lobes of Examples 1 to 3 are narrowed in angle with respect to the main lobes of Comparative Examples 1 to 3.

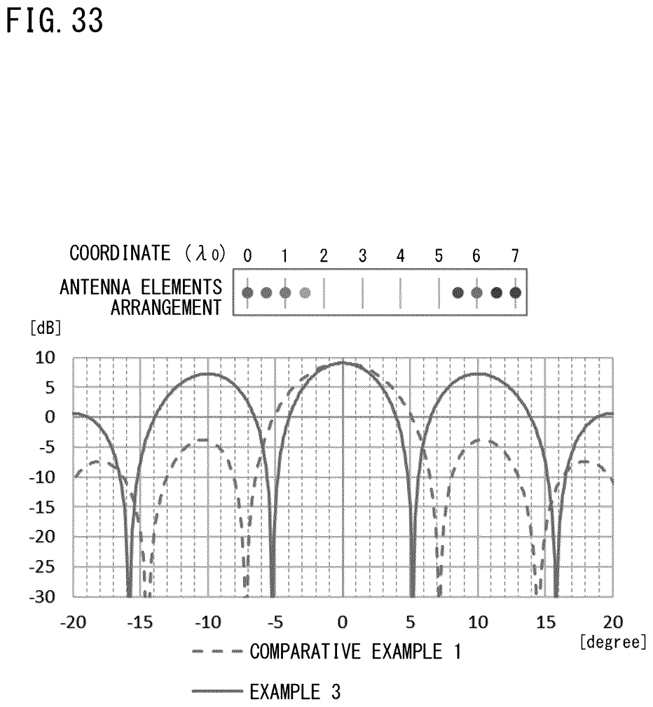

FIG. 33 is a graph showing the composite directivity of receiving antenna 22 according to Example 3 and the composite directivity of receiving antenna 22 according to the Comparative Example 1. In FIG. 33, the horizontal axis represents the angle in the X direction. The vertical axis represents the radiation intensity. In FIG. 33, “Antenna elements arrangement” indicates the outline of the antenna elements arrangement by a circle.

In the graph of FIG. 33, the solid line represents the composite directivity of Example 3 and the dashed line represents the composite directivity of Comparative Example 1.

It is apparent from FIG. 33 that the main lobe of Example 3 is narrowed in angle with respect to the main lobe of Comparative Example 1.

Furthermore, for receiving antenna 22 having eight antenna elements 22A to 22H, the applicant of the present application obtained and examined the 3 dB beam widths for all arrangement patterns of antenna elements 22A to 22H that can be set under the following arrangement conditions. The arrangement condition of the antenna element is that the aperture length of receiving antenna 22 is 7 λ₀, that the minimum interval of the antenna element is 0.5 λ₀, and that the change unit of the coordinates of the antenna element is 0.5 λ₀.

There were a total of 1716 arrangement patterns of the antenna elements under the above conditions. Among them, it was confirmed that there were 683 arrangement patterns of antenna elements that did not satisfy the condition of D_{L}+D_{R}<P_{AVG}×3 of the antenna elements, and all 3 dB beam widths according to the 683 arrangement patterns were equal to or greater than the 3 dB beam width of Comparative Example 1.

[Fifth Experiment: Seven Antenna Elements]

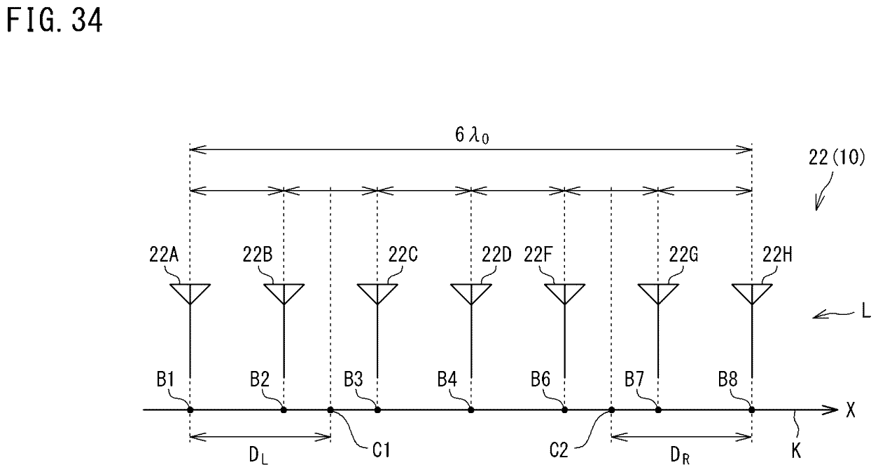

FIG. 34 is a schematic diagram showing the arrangement of receiving antenna 22 of radar 10 used in the fifth experiment. Receiving antenna 22 of FIG. 34 differs from receiving antenna 22 of FIG. 31 in that it does not have antenna element 22E. Therefore, receiving antenna 22 of FIG. 34 includes seven antenna elements 22A. 22B, 22C, 22D, 22F, 22G, and 22H arranged along the X direction.

If the P_{AVG} is 1 λ₀, the antenna aperture length (length in the X direction) of receiving antenna 22 is 6 λ₀ as shown in FIG. 34.

In the fifth experiment, first interval D_{L} and second interval D_{R} of receiving antenna 22 including seven antenna elements 22A to 221H were changed, and the 3 dB beam width was obtained by directivity composite calculation using a point wave source.

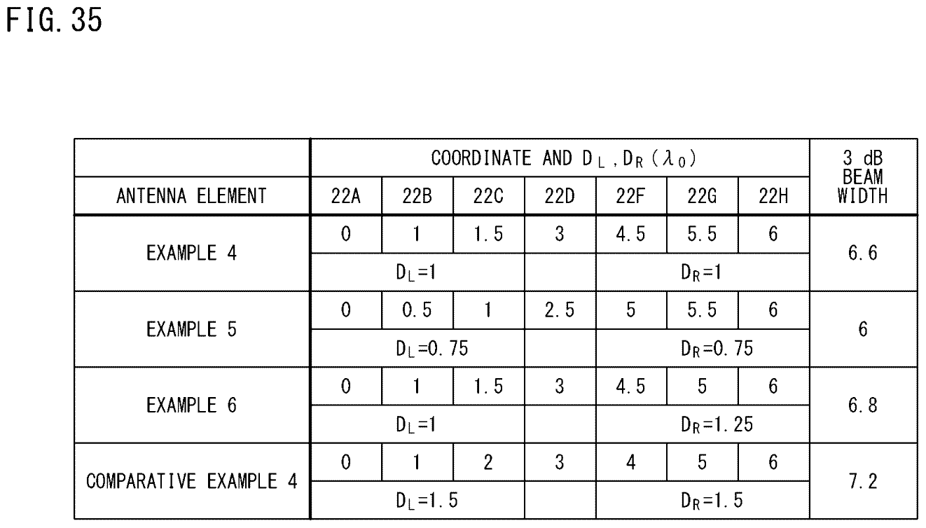

FIG. 35 is a diagram showing an arrangement of antenna elements and a beam width in each of the examples and the comparative example in the fifth experiment.

In FIG. 35, in Example 4, the antenna elements are arranged such that first interval D_{L} is 1 λ₀ and second interval D_{R} is 1 λ₀.

In Example 5, the antenna elements are arranged such that first interval D_{L} is 0.75 λ₀ and second interval D_{R} is 0.75 λ₀.

In Example 6, the antenna elements are arranged such that first interval D_{L} is 1 λ₀ and second interval D_{R} is 1.25 λ₀.

Each of these examples satisfies the condition D_{L}+D_{R}<P_{AVG}×3.

In Comparative Example 4, the antenna elements are arranged such that first interval D_{L} is 1.5 λ₀ and second interval D_{R} is 1.5 λ₀. Note that the antenna elements in Comparative Example 4 have an equal interval arrangement.

Comparative Example 4 does not satisfy the condition of D_{L}+D_{R}<P_{AVG}×3.

As shown in FIG. 35, the 3 dB beam width of Examples 4 to 6 is in the range of 6.0° to 6.8°. In contrast, the 3 dB beam width of Comparative Example 4 is 7.2°. From this result, it can be confirmed that the main lobes of Examples 4 to 6 are narrowed in angle with respect to the main lobe of Comparative Example 4.

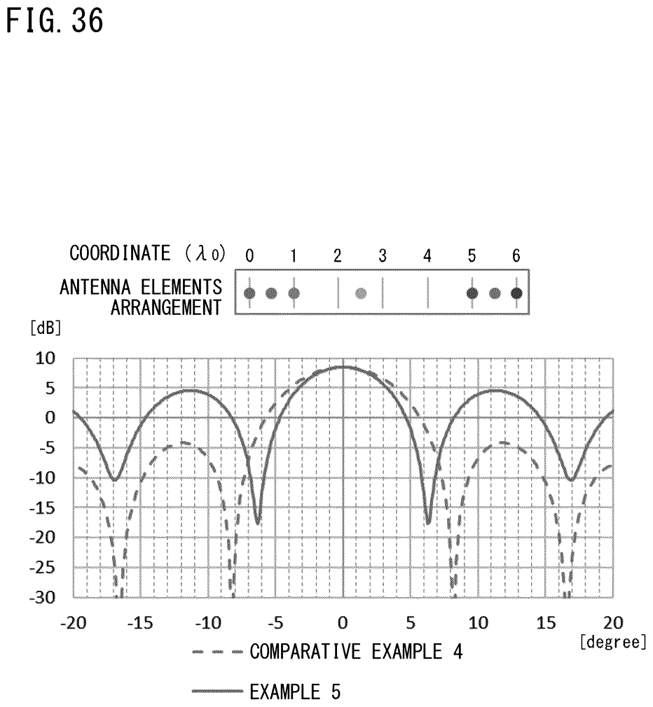

FIG. 36 is a graph showing the composite directivity of receiving antenna 22 according to Example 5 and the composite directivity of receiving antenna 22 according to Comparative Example 4.

In the graph of FIG. 36, the solid line indicates the composite directivity of Example 5, and the dashed line indicates the composite directivity of Comparative Example 4.

It is also apparent from FIG. 36 that the main lobe of Example 5 is narrowed in angle than the main lobe of Comparative Example 4.

Further, the applicant of the present application has obtained and examined the 3 dB beam width for all the arrangement patterns of the configurable antenna elements for receiving antenna 22 having seven antenna elements 22A, 22B, 22C, 22D, 22F, 220, and 22H. The arrangement condition of the antenna element is the same as that in the fourth experiment except that the aperture length of receiving antenna 22 is 6 λ₀.

There were a total of 792 arrangement patterns of the antenna elements under the above conditions. Among them, it was confirmed that there were 358 arrangement patterns of antenna elements that did not satisfy the condition of D_{L}+D_{R}<P_{AVG}×3 of the antenna elements, and all 3 dB beam widths according to the 358 arrangement patterns were equal to or greater than the 3 dB beam width of Comparative Example 1.

[Sixth Experiment: Six Antenna Elements]

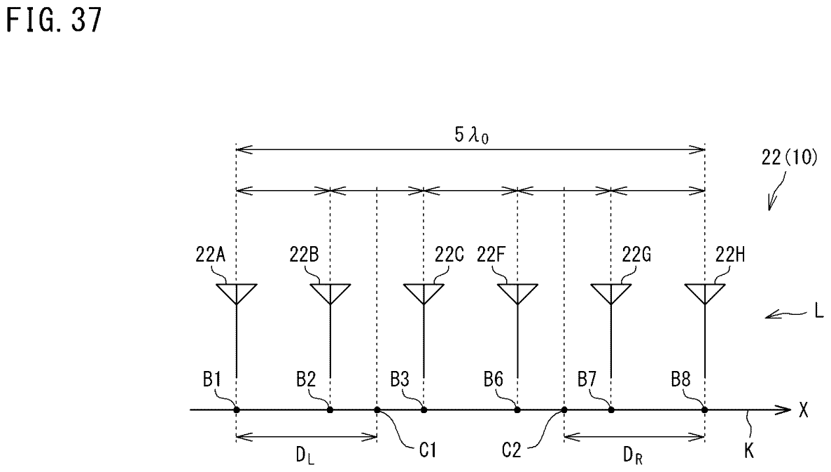

FIG. 37 is a schematic diagram showing the arrangement of receiving antenna 22 of radar 10 used in the sixth experiment. Receiving antenna 22 of FIG. 37 differs from receiving antenna 22 of FIG. 31 in that it does not have antenna elements 22D and 22E. Therefore, receiving antenna 22 of FIG. 37 includes six antenna elements 22A, 22B, 22C, 22F, 22G, and 22H arranged along the X direction.

If average P_{AVG} is 1 λ₀, the antenna aperture length (length in the X direction) of receiving antenna 22 is 5 λ₀, as shown in FIG. 37.

In the sixth experiment, first interval D_{L} and second interval D_{R} of receiving antenna 22 having six antenna elements 22A, 22B, 22C, 22F, 22G, and 22H were changed, and the 3 dB beam width was obtained by the directivity composite calculation using a point wave source.

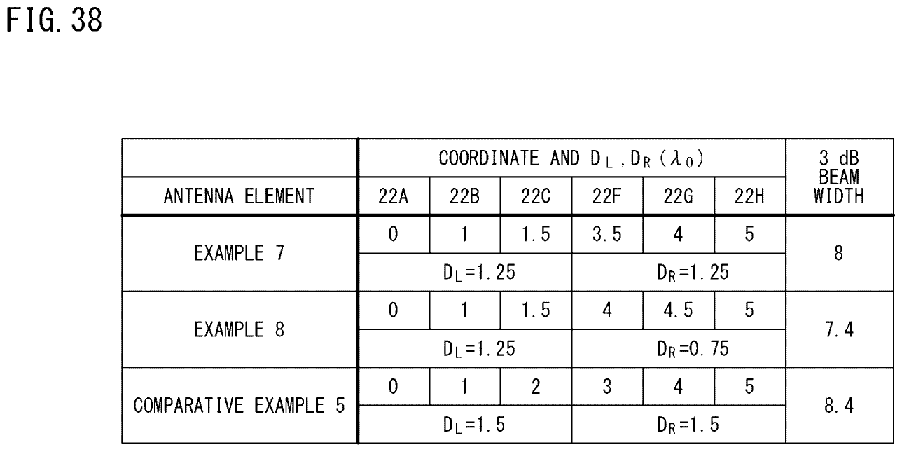

FIG. 38 is a diagram showing an arrangement of antenna elements and a beam width in each of the examples and the comparative example in the sixth experiment. In FIG. 38, in Example 7, the antenna elements are arranged such that first interval D_{L} is 1.25 λ₀ and second interval D_{R} is 1.25 λ₀.

In Example 8, the antenna elements are arranged such that first interval D_{L} is 1.25 λ₀ and second interval D_{R} is 0.75 λ₀.

Each of these examples satisfies the condition D_{L}+D_{R}<P_{AVG}×3.

In Comparative Example 5, the antenna elements are arranged such that first interval D_{L} is 1.5λ₀ and second interval D_{R} is 1.5λ₀. Note that the antenna elements in Comparative Example 5 are in an equal interval arrangement.

Comparative Example 5 does not satisfy the condition of D_{L}+D_{R}<P_{AVG}×3.

As shown in FIG. 38, the 3 dB beam widths of Examples 7 and 8 are 7.40 and 8°. On the other hand, the 3 dB beam width of Comparative Example 5 is 8.4°. From this result, it can be confirmed that the main lobe of Examples 7 and 8 is narrowed in angle with respect to the main lobe of Comparative Example 5.

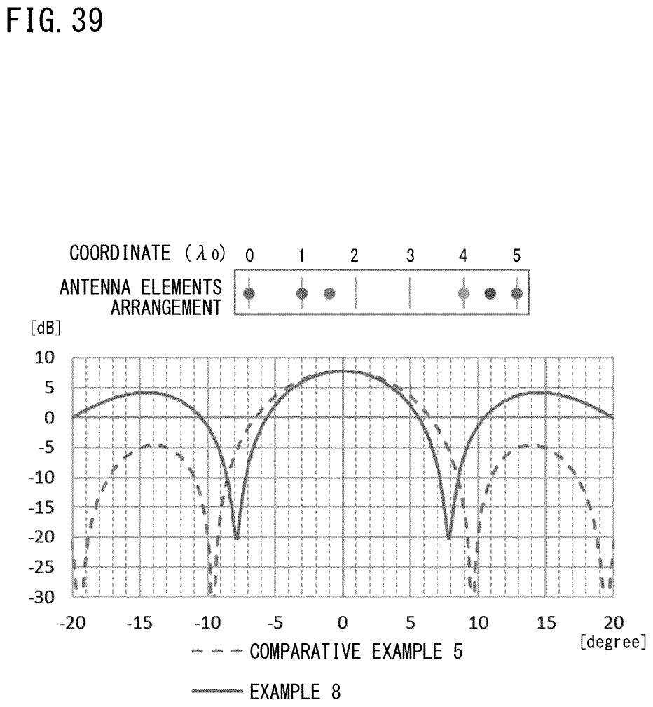

FIG. 39 is a graph showing the composite directivity of receiving antenna 22 according to Example 8 and the composite directivity of receiving antenna 22 according to Comparative Example 5.

In the graph of FIG. 39, the solid line indicates the composite directivity of Example 8, and the dashed line indicates the composite directivity of Comparative Example 5.

It is also apparent from FIG. 39 that the main lobe of Example 8 is narrowed in angle with respect to the main lobe of Comparative Example 5.

Furthermore, the applicant of the present application has obtained and examined the 3 dB beam width for all the arrangement patterns of the antenna elements that can be set for receiving antenna 22 having six antenna elements 22A, 22B, 22C, 22F, 22G, and 22H. The arrangement condition of the antenna element is the same as that in the fourth experiment except that the aperture length of receiving antenna 22 is 5 λ₀. There were a total of 126 arrangement patterns of the antenna elements under the above conditions. Among them, it was confirmed that there were 49 arrangement patterns of antenna elements that did not satisfy the condition of D_{L}+D_{R}<P_{AVG}×3 of the antenna elements, and all 3 dB beam widths according to the 49 arrangement patterns were equal to or greater than the 3 dB beam width of Comparative Example 1.

From the results of the fourth to sixth experiments described above, it can be seen that when P_{AVG} is set to 0.8 λ₀ or more and 1.2 λ₀ or less and the antenna elements are arranged so that D_{L}+D_{R}<P_{AVG}×3 holds, the widening the angle of the main lobe of receiving antenna 22 is suppressed.

It should be understood that the embodiments disclosed herein are illustrative in all respects and are not restrictive. The scope of the present invention is defined not by the above-described meaning but by the claims, and is intended to include meanings equivalent to the claims and all modifications within the scope.

### REFERENCE SIGNS LIST

10 radar
15 substrate
15a one surface
15b edge
20 radar antenna unit
21 transmitting antenna
21A antenna element
21B antenna element
21C antenna element
21C1 antenna element
22 receiving antenna (radar antenna)
22A antenna element
22B antenna element
22C antenna element
22D antenna element
22E antenna element
22F antenna element
22G antenna element
22H antenna element
23 transmitting and receiving circuit
24 signal processing circuit
25A feeder line
25B feeder line
25C feeder line
25D feeder line
26 patch element
28A receiving point
28B receiving point
28C receiving point
28D receiving point
29 patch element
30 feeder line
30A feeder line
31 connecting path
32 feed point
33 connecting path
34 feeder line
34A feeder line
35 feed point
40 transmitting antenna
40C antenna element
40C1 antenna element
44 parasitic element
45 parasitic element
46 parasitic element
47 parasitic element
48 shield portion
C1 first central position
C2 second central position
D_{L} first interval
D_{R} second interval
K straight line
L row
P1 antenna element interval
P2 antenna element interval
P3 antenna element interval
P4 antenna element interval
P_{AVG} interval average
P_{L} first end interval
P_{M} intermediate interval
P_{M1} first intermediate interval
P_{M2} second intermediate interval
P_{R} second end interval
P_{S} distance
P_{T} interval
R road
R1 first lane
R2 second lane
R3 third lane
R4 fourth lane
R5 fifth lane
S width
U upper limit
V vehicle
W1 beam width
W2 beam width
λ₀ free space wavelength

1. A radar antenna unit comprising a receiving antenna configured to receive a reflected wave of a radar wave,
wherein the receiving antenna includes a plurality of receiving antenna elements arranged at an interval so as to form a row along a first direction,
wherein the plurality of receiving antenna elements include
a first end antenna element positioned at a first end of the row,
a second end antenna element positioned at a second end of the row, and
a plurality of intermediate antenna elements positioned between the first end antenna element and the second end antenna element,
wherein, of a plurality of the intervals between the plurality of receiving antenna elements, at least one interval differs from other intervals,
wherein the plurality of receiving antenna elements are disposed such that P_{L}+P_{R}≤P_{AVG}×2 holds, and
wherein P_{AVG} is from 0.8 λ₀ to 1.2 λ₀,
where P_{L} is a first end interval, the first end interval is an interval between the first end antenna element and a first intermediate antenna element, and the first intermediate antenna element is, of the plurality of intermediate antenna elements, an intermediate antenna element positioned adjacent to the first end antenna element,
where P_{R} is a second end interval, the second end interval is an interval between the second end antenna element and a second intermediate antenna element, and the second intermediate antenna element is, of the plurality of intermediate antenna elements, an intermediate antenna element positioned adjacent to the second end antenna element,
where P_{AVG} is an average of the plurality of the intervals, and
where λ₀ is a wavelength corresponding to a predetermined frequency within a frequency bandwidth of the radar wave.

2. The radar antenna unit according to claim 1, wherein the first intermediate antenna element and the second intermediate antenna element are adjacent to each other, and
wherein the plurality of antenna elements are disposed such that P_{L}+P_{M}≥P_{AVG}×2 and P_{M}+P_{R}≥P_{AVG}×2 hold,
where P_{M} is an interval between the first intermediate antenna element and the second intermediate antenna element.

3. The radar antenna unit according to claim 1, further comprising:
a pair of transmitting antennas configured to radiate the radar wave,
wherein the pair of transmitting antennas are disposed along the first direction, and
wherein an interval between the pair of transmitting antennas is larger than a distance between the first end antenna element and the second end antenna element.

4. The radar antenna unit according to claim 3, further comprising:
a substrate where the plurality of receiving antenna elements and the pair of transmitting antennas are disposed in one row along the first direction,
wherein the interval between the pair of transmitting antennas is less than or equal to a value that is determined based on a width of the substrate in the first direction and on the distance.

5. The radar antenna unit according to claim 1, wherein the number of the plurality of intermediate antenna elements is two or three.

6. The radar antenna unit according to claim 2, wherein the number of the plurality of intermediate antenna elements is two.

7. A radar antenna unit comprising a receiving antenna configured to receive a reflected wave of a radar wave,
wherein the receiving antenna includes a plurality of receiving antenna elements arranged at an interval so as to form a row along a first direction,
wherein the plurality of receiving antenna elements include
a first end antenna element positioned at a first end of the row,
a second end antenna element positioned at a second end of the row, and
at least four or more intermediate antenna elements positioned between the first end antenna element and the second end antenna element,
wherein the plurality of intermediate antenna elements include
a first intermediate antenna element positioned adjacent to the first end antenna element, and
a second intermediate antenna element positioned adjacent to the second end antenna element,
wherein, of a plurality of the intervals between the plurality of receiving antenna elements, at least one interval differs from other intervals,
wherein the plurality of receiving antenna elements are disposed such that D_{L}+D_{R}<P_{AVG}×3 holds, and
wherein P_{AVG} is from 0.8 λ₀ to 1.2 λ₀,
where D_{L} is a first interval, the first interval is an interval between a first central position and the first end antenna element in the first direction, and the first central position is a central position in the first direction between the first intermediate antenna element and, of the plurality of intermediate antenna elements, an intermediate antenna element positioned adjacent to the first intermediate antenna element,
where D_{R} is a second interval, the second interval is an interval between a second central position and the second end antenna element in the first direction, and the second central position is a central position in the first direction between the second intermediate antenna element and, of the plurality of intermediate antenna elements, an intermediate antenna element positioned adjacent to the second intermediate antenna element,
where P_{AVG} is an average of the plurality of the intervals, and
where λ₀ is a wavelength corresponding to a predetermined frequency within a frequency bandwidth of the radar wave.

8. A radar comprising:
the radar antenna unit according to claim 1.

9. A radar comprising:
the radar antenna unit according to claim 7.
